(19) United States
(12) Patent Application Publication
(10) Pub. No.: US 2022/0254014 A1
(43) Pub. Date: Aug. 11, 2022

(54) INFORMATION PROCESSING APPARATUS, INFORMATION PROCESSING METHOD, PROGRAM, AND SENSING SYSTEM

(71) Applicant: SONY GROUP CORPORATION, TOKYO (JP)

(72) Inventor: TETSU OGAWA, TOKYO (JP)

(21) Appl. No.: 17/597,073

(22) PCT Filed: Jun. 25, 2020
(86) PCT No.: PCT/JP2020/025082

§ 371 Date: Dec. 23, 2021

(30) Foreign Application Priority Data
Jul. 3, 2019 (JP) 2019-124763

(51) Int. Cl. G06T 7/00; G06T 7/90; G06V 20/10

(52) U.S. Cl. CPC G06T 7/0012; G06T 7/90; G06T 2207/30188; G06T 2207/10024; G06T 2207/10032; G06V 20/188

(57) ABSTRACT

There is provided an information processing apparatus including a macro-measurement analysis calculating section that performs calculation of detection data from a macro-measurement section that performs sensing of a first measurement area of a measurement target at first spatial resolution, a micro-measurement analysis calculating section that performs calculation of detection data from a micro-measurement section that performs sensing of a second measurement area included in the first measurement area of the measurement target at second spatial resolution which is resolution higher than the first spatial resolution, and a complementary analysis calculating section that performs complementary analysis calculation by using a result of calculation by the macro-measurement analysis calculating section, and a result of calculation by the micro-measurement analysis calculating section, and generates complementary analysis information.

### CROSS REFERENCE TO RELATED APPLICATIONS

This application claims the benefit of Japanese Priority Patent Application JP 2019-124763 filed Jul. 3, 2019, the entire contents of which are incorporated herein by reference.

### TECHNICAL FIELD

The present technique relates to an information processing apparatus, an information processing method, a program, and a sensing system, and in particular relates to a technique suitable for generation of results of measurement of vegetation states and the like.

### BACKGROUND ART

For example, there are efforts being made for remotely sensing vegetation states by mounting an image-capturing apparatus on a small-sized aerial vehicle such as a drone, and capturing images of the vegetation state of plants while making the small-sized aerial vehicle move in the air above cultivated land.

PTL 1 discloses a technique of capturing images of cultivated land, and performing remote sensing.

### CITATION LIST

### Patent Literature

### [PTL 1]

Japanese Patent No. 5162890

### SUMMARY

### Technical Problem

By using various optical wavelengths or techniques in addition to measurement of shapes by measurement of visible light (R (red), G (green), and B (blue)), such remote sensing can measure the physical property, the physiological state and the like of a target. However, sensing devices that can be mounted on small-sized aerial vehicles are often subjected to restrictions in terms of size, weight and the like.

For example, hyper spectrum cameras (Hyper Spectrum Camera) that acquire images of light of a large number of wavelengths, and can perform component analysis and the like may typically require a scanning mechanism configured to acquire two-dimensional images, and are large in size. Accordingly, it is difficult to mount them on small-sized drones and the like. In addition, scanning performed by the scanning mechanism may require a certain length of time. Accordingly, hovering is necessary, and gauging time becomes longer. Because of this, it is difficult to perform sufficient sensing of large land such as cultivated land due to restrictions in terms of battery capacity of drones and the like. In addition, vibrations of drones during scanning lower sensing precision.

Although these are matters that apply to hyper spectrum cameras, other than them, there are sensing devices that are not suited to be mounted on small-sized aerial vehicles for reasons in terms of size, weight, operation-related property and the like. Due to restrictions on such sensing devices that can be mounted on small-sized aerial vehicles, it is difficult to apply those sensing devices to more advanced analysis in some cases.

In view of this, it is desirable to provide: a system that can be applied also, for example, to advanced analysis and the like in remote sensing performed by using small-sized aerial vehicles, for example; and an information processing apparatus therefor.

### Solution to Problem

An information processing apparatus according to an embodiment of the present technique includes: a macro-measurement analysis calculating section that performs calculation of detection data from a macro-measurement section that performs sensing of a first measurement area of a measurement target at first spatial resolution; a micro-measurement analysis calculating section that performs calculation of detection data from a micro-measurement section that performs sensing of a second measurement area included in the first measurement area of the measurement target at second spatial resolution which is resolution higher than the first spatial resolution; and a complementary analysis calculating section that performs complementary analysis calculation by using a result of calculation by the macro-measurement analysis calculating section, and a result of calculation by the micro-measurement analysis calculating section, and generates complementary analysis information.

For example, not only sensing at high spatial resolution, but also macro-measurement which is performed at low spatial resolution, but still is capable of highly functional sensing is performed as well to generate analysis results based on information obtained through both types of detection.

In the information processing apparatus according to the embodiment of the present technique explained above, it is considered that the complementary analysis calculation includes calculation processing of complementing the result of calculation by the macro-measurement analysis calculating section by using the result of calculation by the micro-measurement analysis calculating section.

For example, the resolution of the calculation result of macro analysis is increased by using the result of calculation by the micro-measurement analysis calculating section to thereby enhance detection precision.

In addition, in the information processing apparatus according to the embodiment of the present technique explained above, it is considered that the resolution of the result of calculation by the micro-measurement analysis calculating section is higher than the resolution of the result of calculation by the macro-measurement analysis calculating section.

Since the resolution of the result of calculation by the micro-measurement analysis calculating section is high, it can provide complementary information which is not represented in the result of calculation by the macro-measurement analysis calculating section.

In addition, in the information processing apparatus according to the embodiment of the present technique explained above, it is considered that the complementary analysis calculating section generates complementary analysis information which is a physical property value of a particular target discriminated as a result of analysis of the second measurement area by the micro-measurement analysis calculating section, the physical property value being determined as a physical property value in a unit of the first spatial resolution which is a result of analysis by the macro-measurement analysis calculating section.

For example, discrimination of a measurement target is performed by sensing at high spatial resolution. With macro-measurement that allows highly functional sensing, physical property values of the discriminated measurement target are determined.

In the information processing apparatus according to the embodiment of the present technique explained above, it is considered that the physical property value includes information related to photosynthesis of a plant.

Examples of the information related to photosynthesis include SIF (solar-induced chlorophyll fluorescence) and various types of information calculated based on SIF, for example.

In the information processing apparatus according to the embodiment of the present technique explained above, it is considered that the micro-measurement analysis calculating section performs discrimination of a gauging target on the basis of an RGB image or information related to a vegetation index.

For example, RGB images or NDVI (Normalized Difference Vegetation Index) images are used to perform discrimination by a technique such as comparison with a predetermined threshold.

In the information processing apparatus according to the embodiment of the present technique explained above, it is considered that the macro-measurement section performs sensing at a position farther from the measurement target than a position of the micro-measurement section is.

The macro-measurement section performs measurement of a large measurement area from a position farther from the measurement target than a position of the micro-measurement section is. On the other hand, the micro-measurement section performs measurement of a relatively small measurement area from a position closer to the measurement target than a position of the macro-measurement section is.

In the information processing apparatus according to the embodiment of the present technique explained above, it is considered that the macro-measurement section is mounted on an artificial satellite.

The macro-measurement section is mounted on the artificial satellite, and performs measurement of a measurement target such as cultivated land from a remote position in the air.

In the information processing apparatus according to the embodiment of the present technique explained above, it is considered that the micro-measurement section is mounted on an aerial vehicle that can be manipulated wirelessly or by an autopilot.

Examples of the aerial vehicle that can be manipulated wirelessly or by an autopilot include so-called drones, small-sized wirelessly-manipulated fixed-wing airplanes, small-sized wirelessly-manipulated helicopters and the like.

In the information processing apparatus according to the embodiment of the present technique explained above, it is considered that the micro-measurement section has, as a micro-measurement sensor, any of a visible light image sensor, a stereo camera, a laser image detection and ranging sensor, a polarization sensor, or a ToF (Time of Flight) sensor.

Note that laser image detection and ranging sensors are known as so-called Lidar (light detection and ranging).

In the information processing apparatus according to the embodiment of the present technique explained above, it is considered that the macro-measurement section has, as a macro-measurement sensor, any of a multi spectrum camera (Multi Spectrum Camera), a hyper spectrum camera, a Fourier transform infrared spectrophotometer (FTIR: Fourier Transform Infrared Spectroscopy), or an infrared sensor.

It is considered that the information processing apparatus according to the embodiment of the present technique explained above further includes a holding section that holds a complementary analysis calculation program of the complementary analysis calculating section input from an external apparatus.

That is, the program defining the calculation algorithm of the complementary analysis calculating section can be acquired from an external apparatus.

It is considered that the information processing apparatus according to the embodiment of the present technique explained above further includes an output section that generates output image data which is based on the complementary analysis information, and outputs the output image data.

That is, the information of the result of complementary analysis by the complementary analysis calculating section is converted into an image, and the image is made available for presentation to a user.

In the information processing apparatus according to the embodiment of the present technique explained above, it is considered that the output section generates output image data in which a complementary analysis result is color-mapped.

In a case where the complementary analysis result is obtained for each of a plurality of areas, an image for presentation to a user is generated as an image in which a color is applied to each area.

In the information processing apparatus according to the embodiment of the present technique explained above, it is considered that the output section generates output image data obtained by synthesizing a second image and an image in which a complementary analysis result is color-mapped.

The image in which a color is applied to each area, and a second image are synthesized in a form such as overlaying or overwriting, for example.

In the information processing apparatus according to the embodiment of the present technique explained above, it is considered that the second image includes an image based on the calculation result of the micro-measurement analysis calculating section.

As such a second image, an image based on the micro-measurement is used, and this is synthesized with the color mapping image based on the macro-measurement for each area.

In the information processing apparatus according to the embodiment of the present technique explained above, it is considered that the output image data includes image data indicating a complementary analysis result of an image representing an entire part of or a part of the second measurement area in a unit of the first spatial resolution.

Since the second measurement area is included in the first measurement area, it is an area where the macro-measurement and micro-measurement are performed. A result of analysis is made visually recognizable for each unit of the first spatial resolution in an image representing the entire part of or a part of the second measurement area.

In an information processing method according to another embodiment of the present technique, an information processing apparatus executes: macro-measurement analysis calculation processing of performing calculation of detection data from a macro-measurement section that performs sensing of a first measurement area of a measurement target at first spatial resolution; micro-measurement analysis calculation processing of performing calculation of detection data from a micro-measurement section that performs sensing of a second measurement area included in the first measurement area of the measurement target at second spatial resolution which is resolution higher than the first spatial resolution; and complementary analysis calculation processing of performing complementary analysis calculation by using a result of calculation in the macro-measurement analysis calculation processing, and a result of calculation in the micro-measurement analysis calculation processing, and of generating complementary analysis information. Thereby, it is possible for the information processing apparatus to generate advanced analysis result information which combines macro-measurement and micro-measurement regarding a measurement target.

A program according to a further embodiment of the present technique is a program that causes an information processing apparatus to execute the processing of the method explained above. Thereby, realization of a computer apparatus that generates advanced analysis results is enhanced.

A sensing system according to a further embodiment of the present technique includes: a macro-measurement section that performs sensing of a first measurement area of a measurement target at first spatial resolution; a micro-measurement section that performs sensing of a second measurement area included in the first measurement area of the measurement target at second spatial resolution which is resolution higher than the first spatial resolution; and the information processing apparatus mentioned above.

Thereby, a system that performs macro-measurement and micro-measurement, and furthermore generates a result of analysis using measurement results of the macro-measurement and micro-measurement can be constructed.

### BRIEF DESCRIPTION OF DRAWINGS

FIG. 1 is a figure for explaining a macro-measurement section and a micro-measurement section in a sensing system in an embodiment of the present technique.

FIG. 2 is a figure for explaining an example of remote sensing on cultivated land in the embodiment.

FIG. 3 is a figure for explaining measurement by the macro-measurement section and micro-measurement section in the embodiment.

FIG. 4 is a figure for explaining measurement areas and resolution of the macro-measurement section and micro-measurement section in the embodiment.

FIG. 5 is a block diagram of the hardware configuration of an information processing apparatus in the embodiment.

FIG. 6 is a block diagram of the functional configuration of the information processing apparatus in the embodiment.

FIG. 7 is a figure for explaining the gist of an analysis processing example in the embodiment.

FIG. 8 is a flowchart of a processing example in the embodiment.

FIG. 9 is a flowchart of micro-measurement analysis calculation processing in the embodiment.

FIG. 10 is a figure for explaining images to be used in the micro-measurement analysis calculation in the embodiment.

FIG. 11 is a figure for explaining images in a micro-measurement analysis calculation process in the embodiment.

FIG. 12 is a flowchart of complementary analysis calculation processing in the embodiment.

FIG. 13 is a figure for explaining an example of complementary calculation in the embodiment.

FIG. 14 is a figure for explaining an example of analysis results in the embodiment.

FIG. 15 is a figure for explaining an image output by using color mapping in the embodiment.

FIG. 16 is a figure for explaining synthesis of a color mapping image with a second image in the embodiment.

FIG. 17 is a figure for explaining synthesis of a color mapping image with a second image in the embodiment.

### DESCRIPTION OF EMBODIMENT

Hereinafter, explanations of an embodiment are given in the following order.

### <1. Configuration of Sensing System>

### <2. Configuration of Information Processing Apparatus>

### <3. Processing Examples>

### <4. Various Types of Example>

### <5. Summary and Modification>

### 1. Configuration of Sensing System

First, a sensing system of an embodiment is explained.

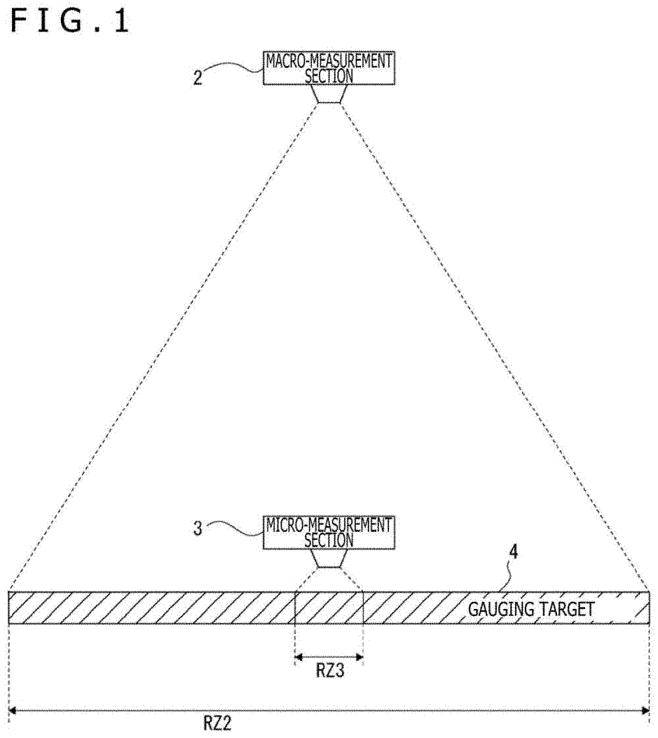

FIG. 1 illustrates a macro-measurement section 2 and a micro-measurement section 3 included in the sensing system.

The micro-measurement section 3 performs sensing at a position relatively close to a gauging target 4. One unit of a measurement area in which sensing is performed is a relatively small area illustrated as a micro-measurement area RZ3. Note that although such one unit depends on a sensor type, it is an area in which image-capturing corresponding to one frame is performed or the like in a case where the sensor type is a camera, for example.

In contrast to this, the macro-measurement section 2 performs sensing from a position farther from the gauging target 4 than a position of the micro-measurement section 3 is. One unit of a measurement area in which sensing is performed is an area illustrated as a macro-measurement area RZ2 which is larger than the micro-measurement area RZ3. It should be noted, however, that one unit of a measurement area in which the macro-measurement section 2 performs sensing may be the same as the micro-measurement area RZ3.

In the case of the present embodiment, the micro-measurement area RZ3 is an area which is the same as or smaller than the macro-measurement area RZ2. That is, the area of the micro-measurement area RZ3 in the gauging target 4 is covered also by the macro-measurement area RZ2. Stated differently, the micro-measurement area RZ3 is an area in which both micro-measurement by the micro-measurement section 3 and macro-measurement by the macro-measurement section 2 are performed.

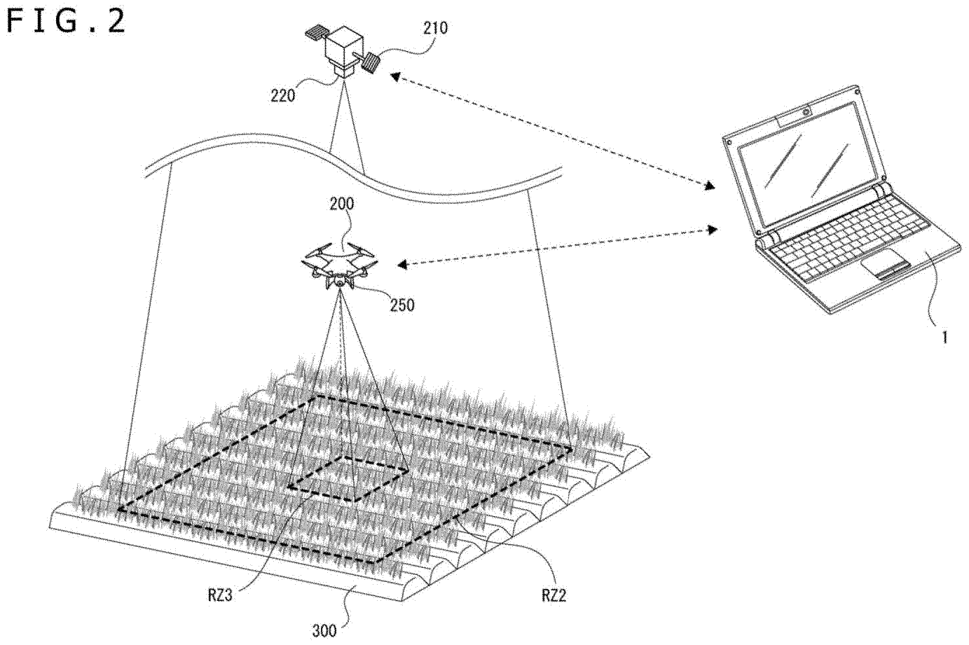

Examples of such sensing systems that use the macro-measurement section 2 and micro-measurement section 3 include a system that performs sensing of the vegetation state of cultivated land 300 illustrated in FIG. 2, for example.

FIG. 2 illustrates how the cultivated land 300 appears. Recently, efforts are being made for remotely sensing the vegetation state by using an image-capturing apparatus 250 mounted on a small-sized aerial vehicle 200 such as a drone, for example, as illustrated in FIG. 2.

The aerial vehicle 200 can move in the air above the cultivated land 300 with wireless manipulation by an operator, an autopilot or the like, for example.

The aerial vehicle 200 has the image-capturing apparatus 250 that is set to capture images of the space below it, for example. When the aerial vehicle 200 moves in the air above the cultivated land 300 along a predetermined route, the image-capturing apparatus 250 captures still images at regular temporal intervals, for example.

Such an image-capturing apparatus 250 attached to the aerial vehicle 200 corresponds to the micro-measurement section 3 in FIG. 1. Then, images captured by the image-capturing apparatus 250 correspond to data obtained through detection as micro-measurement. The image-capturing area of the image-capturing apparatus 250 corresponds to the micro-measurement area RZ3.

In addition, FIG. 2 illustrates an artificial satellite 210 positioned in the air. The artificial satellite 210 has an image-capturing apparatus 220 installed thereon, and is capable of sensing toward the ground surface.

This image-capturing apparatus 220 allows sensing (image-capturing) of the cultivated land 300. That is, the image-capturing apparatus 220 corresponds to the macro-measurement section 2. Then, images captured by the image-capturing apparatus 220 correspond to data obtained through detection as macro-measurement. The image-capturing area of the image-capturing apparatus 220 corresponds to the macro-measurement area RZ2.

Here, it is assumed that the image-capturing apparatus 250 as the micro-measurement section 3 mounted on the aerial vehicle 200, that is, a specific micro-measurement sensor, is: a visible light image sensor (an image sensor that captures R (red), G (green), and B (blue) visible light); a stereo camera; a Lidar (laser image detection and ranging sensor); a polarization sensor; a ToF sensor; a camera for NIR (Near Infra Red: near infrared region) image-capturing; or the like.

In addition, as the micro-measurement sensor, one that performs image-capturing of NIR images and R (red) images, for example, as a multi spectrum camera that performs image-capturing of a plurality of wavelength bands, and can calculate NDVI (Normalized Difference Vegetation Index) from the obtained images may be used, as long as it has a device size that allows it to be operated while being mounted on the aerial vehicle 200. The NDVI is an index indicating the distribution condition or the degree of activity of vegetation.

These are desirably sensors suited for analysis of a phenotypic trait, an environmental response, an environmental state (area, distribution, etc.) and the like of a measurement target, for example. Note that the phenotypic trait is the static form and characteristics of the measurement target. The environmental response is the dynamic form and characteristics of the measurement target. The environmental state is the state of an environment in which the measurement target is present, and is characteristics in terms of the area, the distribution, or the environment in which the measurement target is present, and the like.

In addition, these sensors are desirably relatively small-sized, lightweight sensors that can be easily mounted on the aerial vehicle 200.

On the other hand, possible examples of the image-capturing apparatus 220 as the macro-measurement section 2 mounted on the artificial satellite 210, that is, a specific macro-measurement sensor, include a multi spectrum camera that performs image-capturing of images of a plurality of wavelength bands (e.g., NIR images and R images), a hyper spectrum camera, an FTIR (Fourier transform infrared spectrophotometer), an infrared sensor and the like. In this case, a relatively large-scaled sensing device is tolerated, and it is assumed that one that allows highly precise sensing is used.

Then, these macro-measurement sensors are sensors suited for analysis of various types of physical property values such as information related to photosynthesis, for example.

In addition, these are sensors that can be mounted less easily on the small-sized aerial vehicle 200 for reasons such as device size or weight, and such sensors are mounted on the artificial satellite 210 in the sensing system in the present example.

In addition, tag information is added to images obtained through image-capturing by the image-capturing apparatuses 220 and 250. The tag information includes image-capturing date/time information, positional information as GPS (Global Positioning System) data (latitude/longitude information), image-capturing apparatus information (individual identification information, model information, etc. of a camera), information of respective pieces of image data (information such as image size, wavelengths, or parameters), and the like.

Note that the positional information and image-capturing date/time information correspond also to information that associates images (detection data) of the image-capturing apparatus 220 and images (detection data) of the image-capturing apparatus 250.

Image data and tag information obtained by the image-capturing apparatus 250 mounted on the aerial vehicle 200 and the image-capturing apparatus 220 mounted on the artificial satellite 210 in the manner explained above are sent to an information processing apparatus 1. The information processing apparatus 1 uses the image data and tag information to generate information regarding analysis on the cultivated land 300 as a measurement target. In addition, processing of presenting the result of analysis as images to the user is performed.

The information processing apparatus 1 is realized, for example, as a PC (personal computer), an FPGA (field-programmable gate array), a terminal apparatus such as a smartphone or a tablet, or the like.

Note that although the information processing apparatus 1 has a body separate from the image-capturing apparatus 250 in FIG. 1, a calculating apparatus (microcomputer, etc.) corresponding to the information processing apparatus 1 may be provided in a unit including the image-capturing apparatus 250, for example.

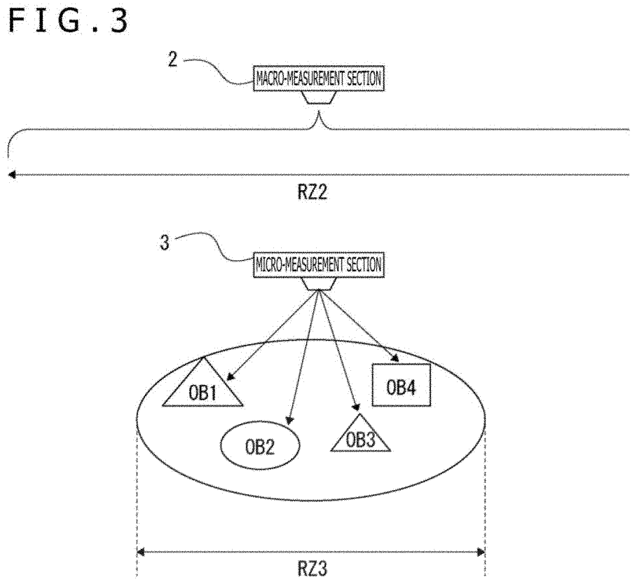

With reference to FIG. 3, roles of the macro-measurement section 2 and micro-measurement section 3 are explained.

The micro-measurement section 3 can perform measurement of each individual in the measurement area RZ3. For example, individuals OB1, OB2, OB3, OB4 ⋅ ⋅ ⋅ are illustrated, and the micro-measurement section 3 allows measurement or determination of the phenotypic trait, the environmental response, and the environmental state of those individuals OB1, OB2, OB3, OB4 ⋅ ⋅ ⋅ , identification of an area based on the phenotypic trait, the environmental response, and the environmental state, and the like. These types of information can be utilized for a sort (discrimination) of a gauging target.

A main purpose of measurement by the micro-measurement section 3 is gauging and diagnosis of each individual. Accordingly, the micro-measurement sensor is supposed to be one that has resolving power and a function that can handle individuals in situations where the individuals have distinct phenotypic traits.

The macro-measurement section 2 detects information related to a plurality of individuals in the large measurement area RZ2.

The detected information can be applied for use by being sorted according to states discriminated by detection of the micro-measurement section 3.

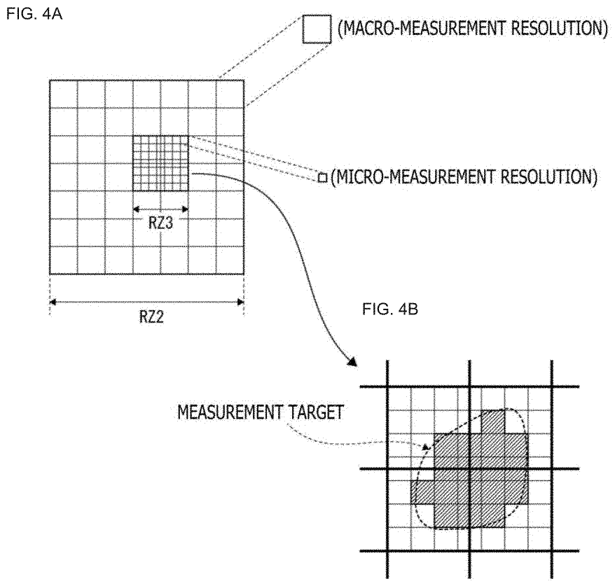

FIG. 4 illustrates resolution. FIG. 4A illustrates the macro-measurement area RZ2 and micro-measurement area RZ3 in a plane view, and FIG. 4B illustrates an enlarged view of part of the plane view.

Large squares represent macro-measurement resolution, and small squares represent micro-measurement resolution. Information obtained at these levels of resolution is equivalent to information of one pixel in a captured image, for example.

That is, a macro-measurement sensor mounted on the macro-measurement section 2 is a sensor having resolution corresponding to the large squares, and a micro-measurement sensor mounted on the micro-measurement section 3 is a sensor having resolution corresponding to the small squares.

For example, in a case where there is a measurement target as indicated by a broken line in FIG. 4B, the phenotypic trait, the environmental response, an area and the like of the measurement target can be categorized at the resolution corresponding to small squares indicated by thin lines, and the physical property value and the like can be measured at the resolution corresponding to large squares indicated by thick lines.

In this case, for example, the physical property value for each large square can be adjusted according to the phenotypic trait, the environmental response, area size, a proportion of area, weight, a distribution amount or the like of the measurement target which can be measured for each small square.

Specifically, assuming, for example, that a measurement target is a “leaf,” the physical property value of the leaf obtained at the macro-measurement resolution corresponding to large squares can be obtained as physical values adjusted according to the shape, the area-size ratio and the like of the leaf that are obtained for each small square (micro-measurement resolution) within those large squares.

Background information that explains why such a sensing system is necessary is mentioned.

As mentioned before, recently, sensing by using aerial vehicles 200 such as drones is performed in many situations, and physical properties, physiological states and the like of a target can be measured by using various optical wavelengths and techniques, in addition to measurement of the phenotypic trait through measurement of visible light (RGB). However, sensing devices that can be mounted on small-sized aerial vehicles 200 are often subjected to restrictions in terms of size, weight and the like.

Hyper spectrum cameras that acquire images of light of a large number of wavelengths, and can perform component analysis and the like may typically require a scanning mechanism in order to acquire two-dimensional images, and are large in size. Accordingly, it is difficult to mount them unless aerial vehicles are large-sized.

In addition, scanning may require a certain length of time, and hovering is necessary, resulting in a longer gauging time which means that the battery capacity of aerial vehicles 200 often does not allow gauging of large land.

In addition, the influence of vibrations of an aerial vehicle 200 during scanning lowers gauging precision in some cases.

In addition, an FTIR method with higher spectral resolution may require a long equipment size in principle, and it is difficult to mount it on aerial vehicles 200.

In a case where highly precise sensing is desired, a large-sized imager is mounted or multiple exposure is performed to thereby be able to improve S/N (signal-noise ratio). However, such a large-sized imager increases the size of an optical system, and thus is not suited to be mounted on an aerial vehicle 200. Multiple exposure which accompanies hovering of the aerial vehicle 200 brings about an increase of gauging time, and the influence of vibrations of the aerial vehicle 200, resulting in lowered precision.

In addition, typically, the temperature of housings of aerial vehicles 200 becomes higher than normal temperature due to irradiation with sunlight.

Thermal noise can be reduced in highly precise sensing by keeping the temperature of sensors low. Although there are sensors such as spectrophotometers to be used indoors that maintain precision by maintaining the sensors at low temperature by Peltier elements or the like, such Peltier elements consume a large amount of electrical power, so that those sensors are not suited to be mounted on aerial vehicles 200 whose electrical power is limited.

Although electrical power efficiency of heat-pump type temperature-adjustment devices that use compressors as seen in air conditioners is high, they do not have size/weight that allow mounting on aerial vehicles 200.

On the other hand, one on which an instrument that can perform advanced sensing is mounted has been applied for satellite sensing. However, it is insufficient in terms of spatial resolution (resolving power).

Mounting of hyper spectrum cameras, an FTIR, and large-sized imagers, and low-temperature control and the like that are explained above are not so difficult in the artificial satellite 210.

It should be noted, however, that in a case where spatial resolution is low, it is difficult not only to categorize shapes simply, but also to measure only targets that are desired to know since various targets are unintentionally captured in one unit of the spatial resolution. In particular, in an example of vegetation measurement, problems such as that soil is unintentionally captured, that shadows are unintentionally captured, and the like occur.

In order to compensate for low spatial resolution by using satellite sensing, a measurement value of a particular target has been determined by inverse calculation that uses “models (radiative transfer characteristics models, etc.)” including information regarding the form of the measurement target.

Meanwhile, although this works well in a case where a gauging target is distributed in a manner consistent with the shape of a model (tropical rain forest in terms of vegetation, etc.), in measurement (scouting) of the cultivated land 300, for example, shapes themselves are what are to be measured in the measurement, and it is difficult to identify the shapes (the shapes of crops vary in the process of growth, they are not growing well or withering for some problem, etc.), so that they are rarely gauged correctly.

Meanwhile, spatial resolution for sensing can be classified into resolution for measurement and output resolution.

For example, in a case where the body weight of a human is desired to know, the body weight of one human only has to be known, and it is not necessary to know the weight per 1 cm³. However, in a case where resolution for measurement is considered and it is attempted to gauge the body weight of a human in a state where he/she is in a swimming pool, it may be required to measure the volume and weight of the human and water while identifying the boundary between the human and water, and discriminating them one from another.

In an example of measurement of the body weight in the swimming pool, in a case where the weight of the entire swimming pool can be measured by macro-measurement and the volume of the human can be measured by micro-measurement, since the specific gravity of water is already known, it becomes possible to determine the specific gravity and body weight of the human by combining both types of information.

This is equivalent to measurement in vegetation sensing in a state where soil and plants are mixedly present, for example, and in a case that the ratio of the soil and plants can be known by the aerial vehicle 200, gauging of spectral reflectance, fluorescence and the like of a certain area can be performed with a satellite, and the reflectance of the soil is already known, it is possible to calculate a measurement result of only the plants similarly.

From such a perspective, in the present embodiment, a system that measures/analyzes two-dimensionally or three-dimensionally the phenotypic trait (morphological phenotypic trait and physiological phenotypic trait), and environmental responses (an environment where a measurement target is located, and responses of the measurement target to the environment) of a measurement target is constructed.

That is, it has two measurement sections, which are the micro-measurement section 3 having spatial resolution that allows identification/extraction/analysis for each individual in a measurement area, and the macro-measurement section 2 that has low spatial resolution, but can measure the phenotypic trait and environmental responses which are not provided by the micro-measurement section 3.

Then, complementary analysis calculation is performed in the information processing apparatus 1 that receives input of the information acquired by the two measurement sections through a wired or wireless connection/a media device to thereby allow analysis of the phenotypic trait and environmental responses based on measurement, by the macro-measurement section 2, of a particular measurement target identified/extracted by the micro-measurement section 3.

In a specific example, in a case where the macro-measurement resolution is 0.5 m, the macro-measurement area is a 500 m square, the micro-measurement resolution is 0.01 m, and the micro-measurement area is a 10 m square, physical property values of plants (information related to photosynthesis, etc.) that are present in the 10 m square can be determined at the resolution of 0.5 m.

At this time, a possible combination is an RGB+NDVI twin lens camera for the aerial vehicle 200, and a hyper spectrum camera for the satellite.

RGB images and NDVI images are obtained by the micro-measurement section 3, and SIF (Solar-Induced chlorophyll Fluorescence) is also captured by the macro-measurement section 2 on the side of the artificial satellite 210 as information related to photosynthesis, for example, to obtain information related to photosynthesis speed.

That is, it is attempted to make sensing by the aerial vehicle 200 advanced, by using physical-property measurement from the side of the artificial satellite 210 without mounting a hyper spectrum camera on the aerial vehicle 200.

### 2. Configuration of Information Processing Apparatus

The information processing apparatus 1 that acquires detection information from the macro-measurement section 2 and micro-measurement section 3, and performs processing such as analysis in the sensing system explained above is explained.

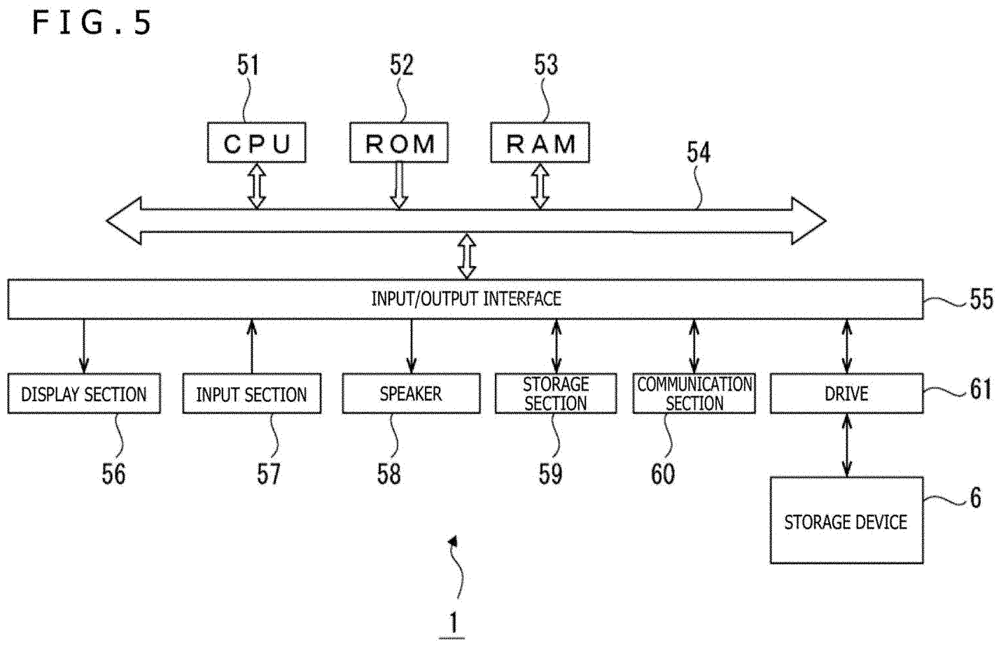

FIG. 5 illustrates the hardware configuration of the information processing apparatus 1. The information processing apparatus 1 includes a CPU (Central Processing Unit) 51, a ROM (Read Only Memory) 52, and a RAM (Random Access Memory) 53.

The CPU 51 executes various types of processing according to programs stored in the ROM 52, or programs loaded from a storage section 59 to the RAM 53. The RAM 53 also stores, as appropriate, data for the CPU 51 to execute various types of processing, and the like.

The CPU 51, the ROM 52, and the RAM 53 are interconnected via a bus 54. An input/output interface 55 is also connected to the bus 54.

A display section 56 including a liquid crystal panel, an organic EL (Electroluminescence) panel or the like, an input section 57 including a keyboard, a mouse and the like, a speaker 58, the storage section 59, a communication section 60 and the like can be connected to the input/output interface 55.

The display section 56 may form a single body with the information processing apparatus 1 or may be equipment of a separate body.

At the display section 56, results of various types of analysis and the like are displayed on a display screen on the basis of instructions from the CPU 51. In addition, at the display section 56, various types of manipulation menus, icons, messages and the like, that is, a GUI (Graphical User Interface), is/are displayed on the basis of instructions from the CPU 51.

The input section 57 means an input device used by a user who uses the information processing apparatus 1.

For example, it is assumed that as the input section 57, various types of manipulation elements or manipulation devices such as a keyboard, a mouse, a key, a dial, a touch panel, a touch pad, or a remote controller are used.

Manipulation of the user is sensed by the input section 57, and signals corresponding to the input manipulation are interpreted by the CPU 51.

The storage section 59 includes a storage medium such as an HDD (Hard Disk Drive) or a solid memory, for example. For example, the storage section 59 stores detection data and analysis results received from the macro-measurement section 2 and micro-measurement section 3, and various other types of information. In addition, the storage section 59 is used also for saving of program data for analysis processing and the like.

The communication section 60 performs communication processing via networks including the internet, and communication with equipment of each peripheral section.

This communication section 60 is a communication device that communicates with the micro-measurement section 3 (image-capturing apparatus 250) or macro-measurement section 2 (image-capturing apparatus 220), for example, in some cases.

A drive 61 is also connected to the input/output interface 55 as necessary, a storage device 6 such as a memory card is attached to the drive 61, and data is written in or read out from the storage device 6.

For example, a computer program read out from the storage device 6 is installed on the storage section 59 as necessary, and data processed at the CPU 51 is stored in the storage device 6. Certainly, the drive 61 may be a record/reproduction drive for a removable storage medium such as a magnetic disk, an optical disc, or a magneto-optical disk. The magnetic disk, the optical disc, the magneto-optical disk and the like are also modes of the storage device 6.

Note that the information processing apparatus 1 in the embodiment is not limited to one configured singly as an information processing apparatus (computer apparatus) 1 with the hardware configuration as illustrated in FIG. 5, but may include a plurality of computer apparatuses formed as a system. The plurality of computer apparatuses may be formed into a system through a LAN or the like or may be arranged at remote locations that are connected by a VPN (Virtual Private Network) or the like using the internet or the like. The plurality of computer apparatuses may include computer apparatuses that can be used by a cloud computing service.

In addition, the information processing apparatus 1 in FIG. 5 can be realized by a personal computer such as a stationary personal computer, a note-book type personal computer or the like, or a mobile terminal such as a tablet terminal or a smartphone. Furthermore, the information processing apparatus 1 of the present embodiment can be mounted also on electronic equipment such as a gauging apparatus, a television apparatus, a monitor apparatus, an image-capturing apparatus or a facility managing apparatus that has functions of the information processing apparatus 1.

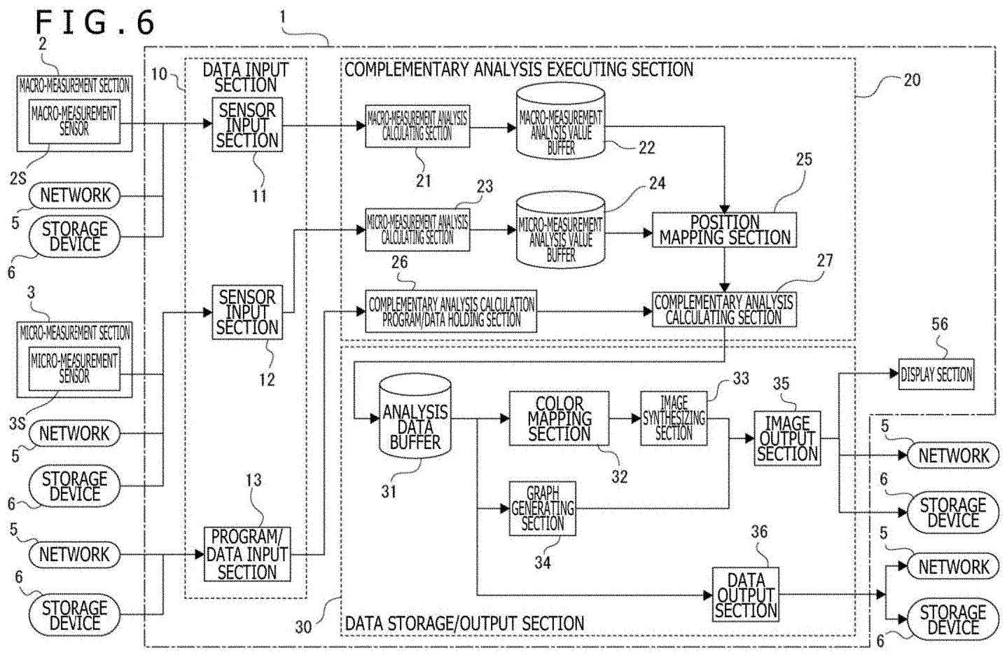

For example, the information processing apparatus 1 with such a hardware configuration has software installed thereon that has the calculation function of the CPU 51, the storage functions of the ROM 52, RAM 53, and storage section 59, the data acquisition function of the communication section 60 and drive 61, and the output function of the display section 56 or the like, and the software realizes the functions to achieve the functional configuration as illustrated in FIG. 6.

That is, the information processing apparatus 1 is provided with a data input section 10, a complementary analysis executing section 20, and a data storage/output section 30 illustrated in FIG. 6, as generally divided sections.

These processing functions are realized by software activated at the CPU 51.

Programs included in the software are downloaded from a network or read out from the storage device 6 (e.g., a removable storage medium) to be installed on the information processing apparatus 1 in FIG. 5. Alternatively, the programs may be stored in advance in the storage section 59 or the like. Then, by the program being activated at the CPU 51, the functions explained above of each section are realized.

In addition, storage functions of various types of buffers or the like are realized by using a storage area of the RAM 53 or a storage area of the storage section 59, for example.

Calculation processing to be performed by the functions illustrated in FIG. 6 can be used for analysis of various types of detection data, and an example of analysis of information related to photosynthesis of vegetation is explained below.

In view of this, background information related to analysis of information related to photosynthesis of vegetation is mentioned first.

SIF (chlorophyll fluorescence) is considered as including information related to photosynthesis speed of plants, and typical gauging performed in the sunlight is measurement using FLD (Fraunhofer. Line-Discrimination) method (solar dark lines: Fraunhofer lines).

However, solar dark lines O₂A used here have a wavelength width which is as thin as approximately 1 nm, and thus sensing with sensors such as a hyper spectrum camera or an FTIR is typically suited for them. These instruments can be easily mounted on the artificial satellite 210, but it is difficult to mount them on the aerial vehicle 200 due to the size and the weight.

In addition, in a case where it is attempted to capture dark lines by making a bandpass filter included in a typical camera, the light amount is so small that it is necessary to make exposure time longer for image-capturing. In this case, the aerial vehicle 200 is stopped temporarily to keep it hovering, so that the measurement time increases, and vibrations of the aerial vehicle 200 cause problems for measurement precision.

In addition, in designing of optical systems, also oblique incidence properties necessitate use of only a central portion of a sensing image by cutting out the central portion from the sensing image, and gauging of a sufficient gauging area is rarely performed.

The transmission wavelength of a filter is affected by the angle of the axis of light entering the filter, and as the obliquity increases, deviation toward the longer-wavelength side increases. That is, at portions that are farther from the center of an image and closer to the circumference, deviation of the transmission wavelength occurs. For example, as one example, in a case where a filter that allows transmission therethrough of light with the wavelength of 760 nm, the obliquity of mere 9 degrees may cause deviation which is as large as 2 nm.

A narrow-band filter with the wavelength width of 1 nm may not provide desired characteristics. In addition, at the center of an image also, light that passes through the center of a lens (the center of the optical axis) and enters the filter enters the filter at a right angle, but since light that passes through circumferential portions of the lens to form an image enters the filter obliquely, the half width increases.

Using a large lens for improvement deteriorates the property in terms of mounting on the aerial vehicle 200, and stopping down a lens darkens an image, which means that the exposure time has to be increased further. These factors make mounting on the aerial vehicle 200 significantly difficult.

On the other hand, measurement of NDVI by using an RGB camera, or an R camera and an NIR camera is widely performed with the aerial vehicle 200 such as a drone, and discrimination related to the shape of a gauging target can be performed by using these values, for example. Certainly, such a shape can be gauged directly by a stereo camera or the like.

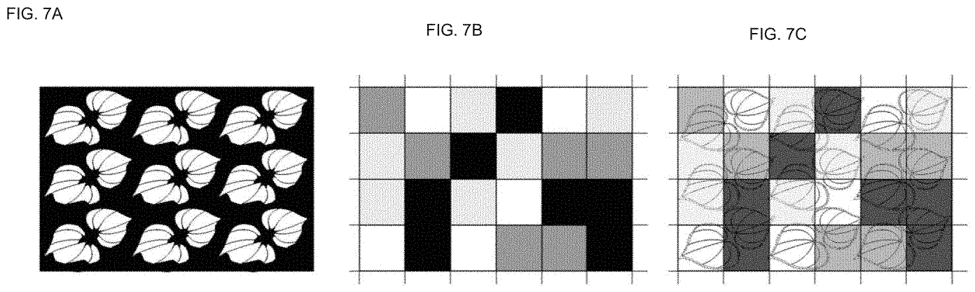

For example, in FIG. 7A, only leaves (sun leaves) that are in the gauging area RZ3 of an image obtained by capturing plants, and are facing sunlight are extracted. For example, only plants are extracted by setting NDVI>0.5 for an NDVI image (e.g., excluding the portion of an image of soil), and furthermore portions corresponding to or higher than a certain NIR reflection intensity are extracted. Thereby, only sun leaves can be extracted.

Since it is considered that the ratio of contribution of sun leaves to the photosynthesis amount is significant, extraction of only sun leaves is meaningful for analysis of information related to photosynthesis.

Note that in FIG. 7A, lines equivalent to the resolution of the micro-measurement sensor 3S are additionally illustrated at the upper portion and the left portion of the image.

While a particular gauging target is interpreted/extracted from a gauging area by measurement at high resolution in this manner, physical property amounts (numerical value related to photosynthesis) that are obtained by the macro-measurement sensor 2S are combined in a well-devised manner. Thereby, the physical property amounts can be determined at the resolution of macro-measurement.

FIG. 7B illustrates an image of physical property values (e.g., SIF) obtained by the macro-measurement sensor 2S. The value of SIF is obtained for each square.

Using, as this SIF value for each square, not a direct result of measurement, but a value adjusted on the basis of the ratio of sun leaves extracted as in FIG. 7A or the like, for example, gives more meaningful information.

FIG. 7C illustrates an example of presentation of a result of analysis to a user. Since display of only physical property values as in FIG. 7B does not give easily-understandable information to the user, they are synthesized with an RGB image, and the synthesized image is presented, for example. Thereby, the user can easily understand the gauging target and the gauging result.

Note that display output to be performed by synthesizing physical property value of a result of analysis, and an RGB image is merely one example, and not an RGB image, but an NDVI image or an image in FIG. 7A in which sun leaves are extracted may be synthesized and output, for example.

Respective functions in FIG. 6 are explained, assuming a case where analysis of information related to photosynthesis is performed in the manner explained above.

First, the macro-measurement section 2, the micro-measurement section 3, networks 5, and storage devices 6 are illustrated as external apparatuses of the information processing apparatus 1 in FIG. 6.

The macro-measurement section 2 is mounted on the artificial satellite 210 as mentioned above, for example. The macro-measurement sensor 2S is a large-sized sensor such as a hyper spectrum camera or an FTIR, and is a sensor that can be easily mounted on the artificial satellite 210, but not on the aerial vehicle 200. This is typically an invisible light sensor, and is mainly used for measuring physical properties.

The micro-measurement section 3 is mounted on the aerial vehicle 200. The micro-measurement sensor 3S is a small-sized sensor such as an RGB camera or a stereo camera, and a sensor that can be easily mounted on the aerial vehicle 200. Typically, it is a sensor that mainly captures visible light, and is mainly used for measuring the phenotypic trait and the environmental response of a measurement target.

It is assumed that the network 5 includes the internet, a home network, a LAN (Local Area Network) and the like, a satellite communication network, and various other types of network, for example.

It is assumed that the storage devices 6 are mainly removable recording media such as a memory card or disk-like recording medium as mentioned above.

In the information processing apparatus 1, the data input section 10 illustrated in FIG. 6 has a function of receiving data input from the external apparatuses explained above, and has sensor input sections 11 and 12, and a program/data input section 13.

The sensor input section 11 receives input of information obtained through detection by the macro-measurement sensor 2S of the macro-measurement section 2. Data obtained through detection by the macro-measurement sensor 2S is received directly through communication between the macro-measurement section 2 and the communication section 60 in FIG. 5 in some cases, for example.

Alternatively, data obtained through detection by the macro-measurement sensor 2S is received by the communication section 60 via the network 5 in some cases.

Furthermore, data obtained through detection by the macro-measurement sensor 2S is acquired via the storage device 6 in some cases.

The sensor input section 12 receives input of information obtained through detection by the micro-measurement sensor 3S of the micro-measurement section 3. Data obtained through detection by the micro-measurement sensor 3S is received directly through communication between the micro-measurement section 3 and the communication section 60 in some cases, is received by the communication section 60 via the network 5 in some cases, furthermore is acquired via a storage device 6 in some cases, and is received in other manners in some cases, for example.

Note that the sensor input sections 11 and 12 may be configured to perform preprocessing such as light-source spectral correction.

The program/data input section 13 acquires suitable for programs by downloading them from a server through a network 5, reading out them from a storage device 6, or in other manners.

The complementary analysis executing section 20 has a macro-measurement analysis calculating section 21, a macro-measurement analysis value buffer 22, a micro-measurement analysis calculating section 23, a micro-measurement analysis value buffer 24, a position mapping section 25, a complementary analysis calculation program/data holding section 26, and a complementary analysis calculating section 27.

The macro-measurement analysis calculating section 21 performs calculation of determining the amount of a substance component or the like from detection data of the macro-measurement sensor 2S acquired by the sensor input section 11.

For example, the macro-measurement analysis calculating section 21 calculates vegetation indices, SIF by NIRS (near-infrared spectroscopy) or the FLD method from multi-wavelength data from a hyper spectrum camera or an FTIR, or the like.

The macro-measurement analysis value buffer 22 temporarily holds data having been processed by the macro-measurement analysis calculating section 21.

For example, the macro-measurement analysis value buffer 22 holds SIF calculated by the macro-measurement analysis calculating section 21, positional information notified from the macro-measurement section 2, or the like.

The micro-measurement analysis calculating section 23 performs calculation for discriminating/extracting an image from detection data of the micro-measurement sensor 3S acquired by the sensor input section 12.

For example, the micro-measurement analysis calculating section 23 performs discrimination or the like by performing image recognition processing. Alternatively, the micro-measurement analysis calculating section 23 may classify targets by using colors, luminance values or the like, or may determine the amounts of substance components and use the amounts for discrimination.

With the processing, the micro-measurement analysis calculating section 23 discriminates the portions of sun leaves, for example.

The micro-measurement analysis value buffer 24 temporarily holds data having been processed by the micro-measurement analysis calculating section 23.

For example, the micro-measurement analysis value buffer 24 holds information that allows discrimination of the sun-leaf portions determined in the micro-measurement analysis calculating section 23, positional information notified from the micro-measurement section 3, and furthermore RGB images, NDVI image and the like.

The position mapping section 25 performs calculation for extracting common points from image groups with different levels of resolving power or image-capturing units (the measurement areas RZ2 and RZ3). For example, GPS information, orthomosaicing or the like is used to perform positional alignment on information processed at the macro-measurement analysis calculating section 21 and information processed at the micro-measurement analysis calculating section 23.

The complementary analysis calculating section 27 performs complementary analysis calculation by using a result of calculation by the macro-measurement analysis calculating section 21, and a result of calculation by the micro-measurement analysis calculating section 23.

For example, for the gauging area RZ3 of micro-measurement, it uses information of the macro-measurement section 2 to perform calculation for determining the phenotypic trait or the environmental response of a particular target discriminated by the micro-measurement section 3 in the macro-measurement resolving-power unit.

It is considered that this complementary analysis calculation by the complementary analysis calculating section 27 is calculation processing of complementing a result of calculation by the macro-measurement analysis calculating section 21 by using a result of calculation by the micro-measurement analysis calculating section 23. Thereby, the resolution of a calculation result of macro analysis can be increased by using a result of calculation by the micro-measurement analysis calculating section, and detection precision can be enhanced.

In addition, due to the difference between the micro-measurement resolution and the macro-measurement resolution, the resolution of the result of calculation by the micro-measurement analysis calculating section 23 can be made higher than the resolution of the result of calculation by the macro-measurement analysis calculating section 21. Because of this, by performing, as the complementary analysis calculation, calculation processing of complementing the result of calculation by the macro-measurement analysis calculating section 21 by using the result of calculation by the micro-measurement analysis calculating section 23, it becomes possible to obtain a complementation result in which information not represented in the result of calculation by the macro-measurement analysis calculating section is complementarily added.

The complementary calculation program/data holding section 26 holds programs/data for complementary calculation that are acquired by the program/data input section 13. Calculation processing of the complementary analysis calculating section 27 is performed on the basis of the programs/data.

The data storage/output section 30 has an analysis data buffer 31, a color mapping section 32, an image synthesizing section 33, a graph generating section 34, an image output section 35, and a data output section 36.

The analysis data buffer 31 temporarily stores information regarding a result of calculation by the complementary analysis calculating section 27.

In a case where the complementary analysis calculating section 27 determines the SIF amount of only sun leaves, the analysis data buffer 31 holds the information. In addition, RGB images or NDVI images are held in some cases.

For visually displaying physical values, the color mapping section 32 performs calculation processing of converting a certain range of the physical values into color-gradations from blue to red by using levels of the three primary colors RGB, for example.

The image synthesizing section 33 performs calculation processing of arranging color-mapped physical value data in such a manner that the data corresponds to their original spatial areas in an image or overlay-displaying the data on an RGB image.

For visually displaying data, the graph generating section 34 performs calculation processing of generating a graph by displaying physical values with polygonal lines or converting two-dimensional physical values into a scatter diagram.

The image output section 35 outputs image data generated by the processing of the color mapping section 32, the image synthesizing section 33, and the graph generating section 34 to the external display section 56, and makes the image data displayed on the display section 56. Alternatively, the image output section 35 performs output for transmitting the generated image data to an external apparatus by using the network 5 or for converting the image data into a file and storing the file in the storage device 6.

The data output section 36 outputs information regarding a result of calculation by the complementary analysis calculating section 27 stored in the analysis data buffer 31. For example, the data output section 36 performs output for transmitting information regarding a complementary analysis result (e.g., the values of SIF, etc.) to an external apparatus by using the network 5 or for converting the information into a file and storing the file in the storage device 6.

### 3. Processing Examples

Processing example of the information processing apparatus 1 having the functions explained above is explained.

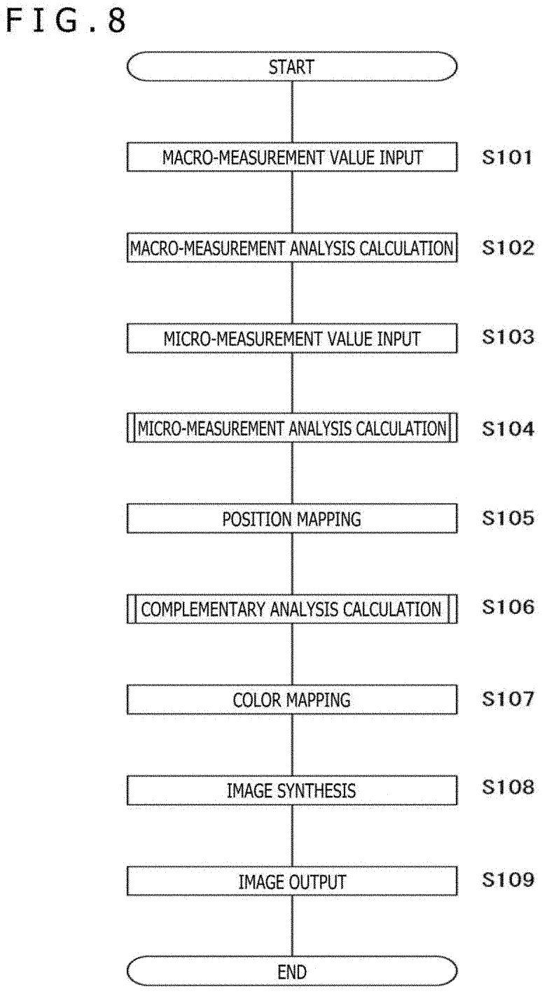

FIG. 8 illustrates a processing example of the information processing apparatus 1.

At Step S101, the information processing apparatus 1 receives input of measurement values of the macro-measurement section 2 by the function of the sensor input section 11.

At Step S102, the information processing apparatus 1 performs macro-measurement analysis calculation by the function of the macro-measurement analysis calculating section 21. For example, SIF calculation is performed to obtain information related to photosynthesis. Known SIF calculation includes the FLD method performed by using dark lines in the spectrum of sunlight.

At Step S103, the information processing apparatus 1 receives input of measurement values of the micro-measurement section 3 by the function of the sensor input section 12.

At Step S104, the information processing apparatus 1 performs micro-measurement analysis calculation by the function of the micro-measurement analysis calculating section 23. For example, extraction of sun leaves is performed.

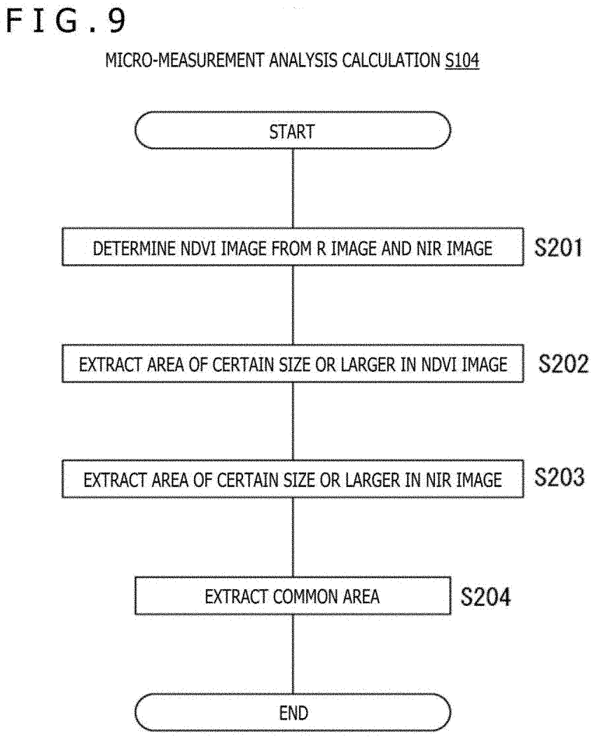

A processing example of this micro-measurement analysis calculation at Step S104 is illustrated in FIG. 9.

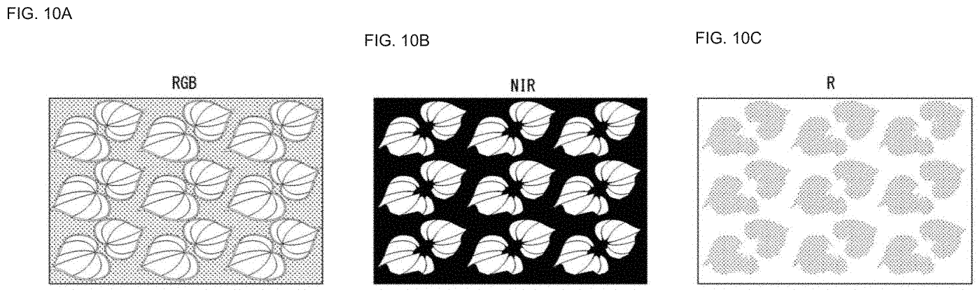

Note that it is assumed that the micro-measurement analysis calculating section 23 has acquired an RGB image, an NIR image, and an R image illustrated in FIG. 10.

At Step S201 in FIG. 9, the micro-measurement analysis calculating section 23 determines an NDVI image from the R image and the NIR image. The NDVI value is determined as follows.

NDVI=(NIR−R)/(NIR+R)

Here, “R” is the reflectance of red in the visible range, and “NIR” is the reflectance of the near infrared region.

The value of NDVI is a numerical value normalized to a value between “−1” to “1.” The larger the value is in the positive direction, the higher the vegetation density is.

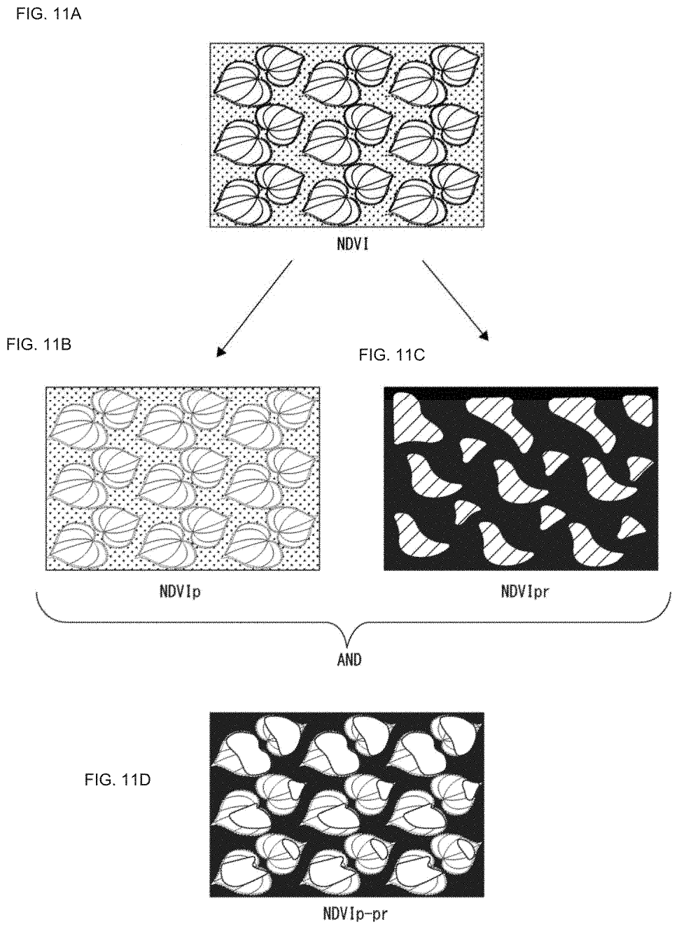

FIG. 11A schematically illustrates an NDVI image based on the NDVI value.

At Step S202, the micro-measurement analysis calculating section 23 extracts an area in the NDVI image where the NDVI value is equal to or higher than a certain value. That is, an image NDVIp (NDVIPlants Filtered) of FIG. 11B representing a result of extraction of pixels where the NDVI value is equal to or larger than a predetermined threshold is generated. The image NDVIp representing a result of extraction of pixels where the NDVI value is equal to or larger than a predetermined threshold can be said to be a filtering image representing a result of extraction of a plant portion.

At Step S203, the micro-measurement analysis calculating section 23 extracts an area in the NDVI image where the NIR value is equal to or higher than a certain value. That is, an image NDVIpr (NDVIPar Filtered) of FIG. 11C representing a result of extraction of pixels where the NIR value is equal to or larger than a predetermined threshold is generated.

The image NDVIp representing a result of extraction of pixels where the NIR value is equal to or larger than a predetermined threshold can be said to be a filtering image representing a result of extraction of portions lit by sunlight.

At Step S204, the micro-measurement analysis calculating section 23 extracts an area where NDVI is equal to or higher than a certain value, and the NIR value is equal to or higher than a certain value. That is, extraction is performed by an AND operation of FIG. 11B and FIG. 11C to generate an image NDVIp-pr (NDVIPlants Filtered Par Filtered) in FIG. 11D.

The image NDVIp-pr corresponds to information (image) representing a result of extraction of sun leaves.

After Step S104 in FIG. 8 is performed by the processing explained above, at Step S105, the information processing apparatus 1 performs position mapping by the function of the position mapping section 25.

That is, positional alignment between the area of the macro-measurement resolution (the SIF amount of each area) obtained by the macro-measurement analysis calculation, and the image NDVIp-pr of FIG. 11D which is a micro-measurement analysis calculation result is performed.

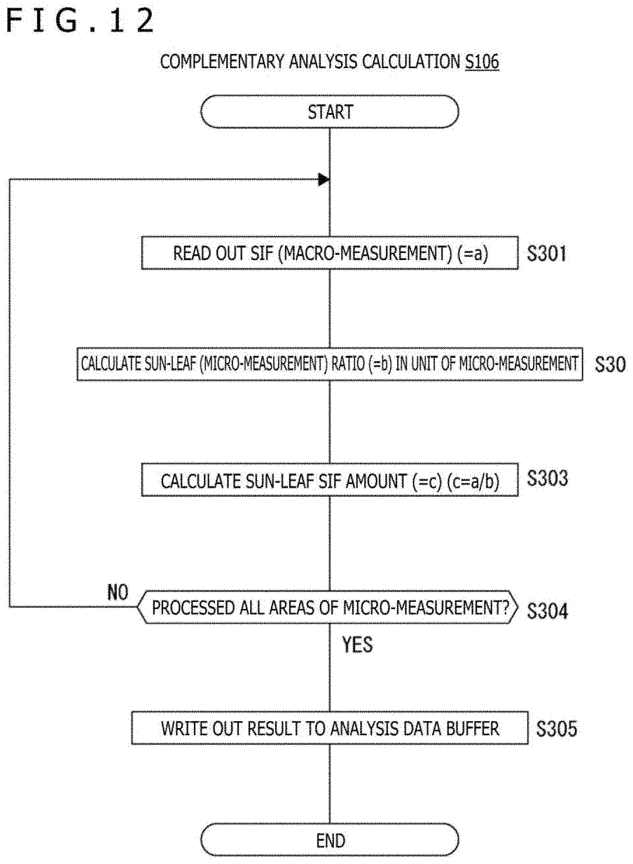

At Step S106, the information processing apparatus 1 performs complementary analysis calculation by the function of the complementary analysis calculating section 27. A processing example of this complementary analysis calculation is illustrated in FIG. 12.

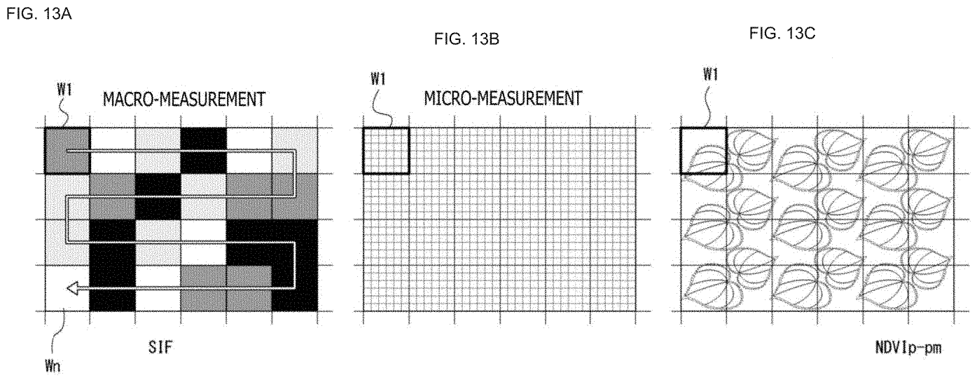

Note that SIF based on macro-measurement is schematically illustrated in FIG. 13A. SIF is determined for each square (macro resolution units W1 to Wn) illustrated as the macro-measurement resolution. Differences in the SIF amount are represented by color density in the figure.

FIG. 13B illustrates the micro-measurement resolution by frames with thin lines, and the one macro resolution unit W1 of the macro-measurement resolution by a thick line. FIG. 13C illustrates the one macro resolution unit W1 by a thick line on an image NDVIp-pr mentioned above representing extracted sun leaves.

Complementary analysis calculation is performed for each macro resolution unit equivalent to the micro-measurement area. As explained with reference to FIG. 4 and the like, the micro-measurement area RZ3 is included in the macro-measurement area RZ2. In complementary analysis calculation, measurement values of macro resolution units at positions equivalent to the micro-measurement area RZ3 are sequentially referred to, in the macro-measurement area RZ2. That is, the processing is performed sequentially from the macro resolution units W1 to Wn in FIG. 13A.

At Step S301, the complementary analysis calculating section 27 reads out SIF, and assigns it to a variable a.

For example, first, SIF of the macro resolution unit W1 is treated as the variable a.

At Step S302, the complementary analysis calculating section 27 calculates the sun-leaf ratio in a current target macro resolution unit, and assigns the calculated sun-leaf ratio to a variable b. For example, in the macro resolution unit W1 in FIG. 13B and FIG. 13C, the area size (e.g., pixel counts) of portions extracted as sun leaves, and portions other than them are determined, and the ratio of the sun-leaf portions is determined.

At Step S303, the complementary analysis calculating section 27 calculates a sun-leaf SIF amount (=c) in the current target macro resolution unit. c is defined as a/b. That is, by dividing the SIF amount of one macro resolution unit with the sun-leaf ratio, the sun-leaf SIF amount in the macro resolution unit is determined. For example, in a case where the SIF amount (variable a)=0.1, and the sun-leaf ratio (variable b)=0.5, the sun-leaf SIF amount c is 0.2.

The calculated sun-leaf SIF amount c is stored as the value of the SIF amount in the current target macro resolution unit.

The processing explained above is repeated by returning from Step S304 to S301 until the processing is performed for all micro-measurement areas. That is, the value of the sun-leaf SIF amount c is determined as explained above sequentially for each of the macro resolution unit W1 to the macro resolution unit Wn.

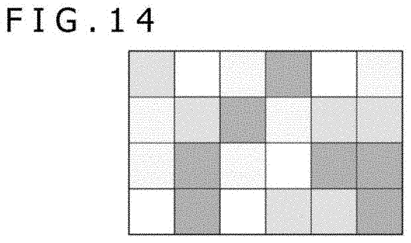

After the processing is completed for all macro resolution units equivalent to micro-measurement areas, the complementary analysis calculating section 27 proceeds to Step S305, and writes out a complementary analysis result to the analysis data buffer 31. In this case, the value of the sun-leaf SIF amount c is written as a result of analysis for each of the macro resolution unit W1 to the macro resolution unit Wn. FIG. 14 schematically illustrates a result of analysis determined as the value of the sun-leaf SIF amount c. That is, the SIF amount of each macro resolution unit in FIG. 13A is expressed as information corrected according to the sun-leaf ratio.

After Step S106 in FIG. 8 is completed by performing the processing explained above, the information processing apparatus 1 performs color mapping at Step S107, image synthesis at Step S108, and image output at Step S109 by the function of the data storage/output section 30.

Thereby, a user can check the result of analysis on the display section 56 or the like.

An example of output images having been subjected to the color mapping and the like in this case is explained.

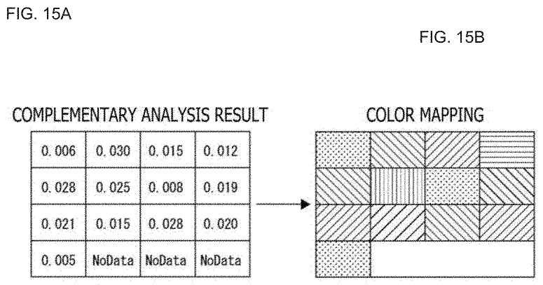

FIG. 15 illustrates an example of generation of an image in which color application (color mapping) is performed on a complementary analysis result for each macro resolution unit obtained in the manner mentioned above. “Color application” mentioned here is to set a color corresponding to each numerical value range in advance, and select a color according to a target value, and allocate the color to a pixel of interest.

FIG. 15A illustrates SIF (the value of c explained above) for each macro resolution unit obtained as a complementary analysis result. Color application is performed for such a value of SIF to generate a color mapping image as illustrated in FIG. 15B. This corresponds to an image in which a color corresponding to SIF (the value of c) is allocated for each area.

Note that the figure illustrates differences of colors by the types of oblique lines, dots and the like. In addition, macro resolution units where there are no valid SIF values (e.g., a portion where there are no sun leaves, etc.) are indicated by “NO DATA.” The background color (white) is allocated to areas indicated by “NO DATA,” for example.

Presentation of such a color mapping image to a user allows expression of SIF of the area of each macro resolution unit by a color, and an image that allows the user to easily know the photosynthesis condition of each area is given.

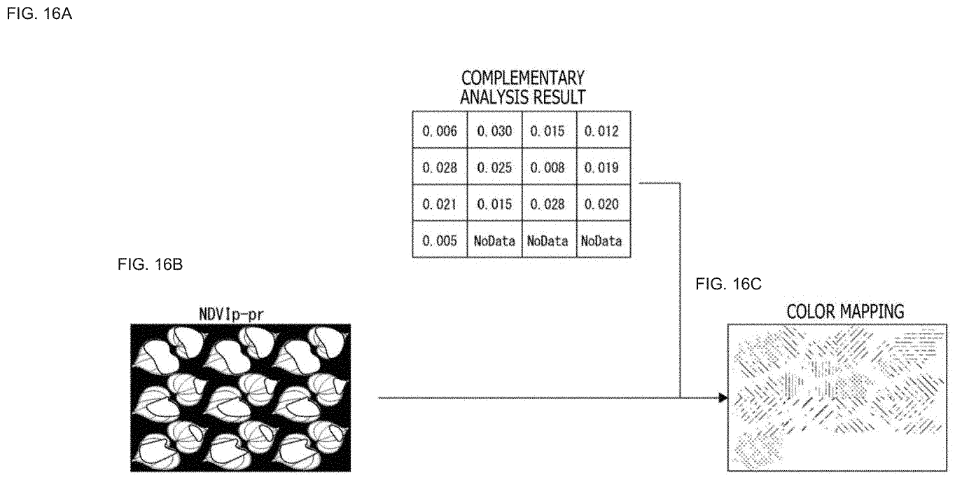

Next, FIG. 16 illustrates an example of synthesis of an image with an applied color to a portion corresponding to a particular state of vegetation. FIG. 16A illustrates SIF (the value of c explained above) for each macro resolution unit obtained as a complementary analysis result. FIG. 16B illustrates an image NDVIp-pr representing extracted sun leaves.

Then, color application is performed on a sun-leaf portion in each macro resolution unit to generate a color mapping image as illustrated in FIG. 16C. It is an image in which only portions of sun leaves are colored corresponding to their SIF. Accordingly, it is an image that allows a user to easily know the distribution of sun leaves in each area, and a photosynthesis condition therein.

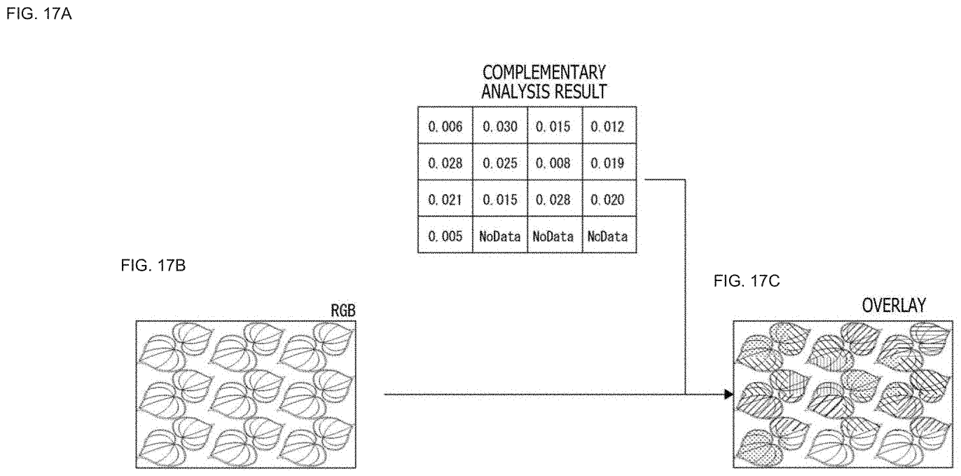

Next, FIG. 17 illustrates an example of overlay display on a visible light image (RGB image).

FIG. 17A illustrates SIF (the value of c explained above) for each macro resolution unit obtained as a complementary analysis result. FIG. 17B illustrates an RGB image.

Then, as illustrated in FIG. 17C, a color allocated to each macro resolution unit according to a SIF value is overlaid on the RGB image. The figure illustrates a state where corresponding pixel portions are colored.

That is, it is an image in which colors indicating a result of analysis are expressed on the RGB image. Accordingly, it is an image usually recognized by a user visually, but the photosynthesis condition, for example, is represented thereon, and the user can easily know the vegetation condition thereon.

Note that the allocated colors may not be overlaid, but corresponding pixels may be written over by the allocated colors.

For example, an output image is generated in the manner illustrated in FIG. 15, FIG. 16, and FIG. 17 explained above, and the generated image is displayed on the display section 56, transmitted to an external apparatus by using the network 5, or converted into a file to be stored in the storage device 6, to allow a user to use a result of analysis.

### 4. Various Types of Example

Meanwhile, although in the processing example explained above, a result of analysis of SIF obtained by taking into consideration sun-leaf portions is output, there is possible modification in that case, and various types of example of other sensing and output information. Hereinbelow, examples of combinations of macro-measurement and micro-measurement, and output are illustrated.
Macro-measurement: SIF
Micro-measurement: RGB, NDVI, and NIR reflectance (for sun leaf discrimination)
Output: information related to a photosynthesis state

This is a combination equivalent to the processing example explained above.

Although sun leaves are simply extracted on the basis of micro-measurement in the processing example mentioned above, weighting may be used for sun leaves and shade leaves (leaves that are not lit by sunlight).
Macro-measurement: SIF
Micro-measurement: RGB, NDVI, NIR reflectance (for sun leaf discrimination), and a polarization sensor (or a stereo camera or a ToF sensor) (for gauging angles of leaves)
Output: information related to a photosynthesis state

By gauging the angles of leaves, information regarding the angles of leaves can be used as extraction conditions or can be used in combination with weighting to enhance the precision.
Macro-measurement: vegetation indices such as NDVI
Micro-measurement: RGB (for discrimination of soil and plants)
Output: information related to leaves and individuals such as chlorophyll concentration of leaves

Such an example facilitates construction of a service to provide vegetation indices such as NDVI which is a combination of satellite sensing and the aerial vehicle 200 such as a drone on which a typical RGB camera is mounted.
Macro-measurement: vegetation indices such as NDVI
Micro-measurement: RGB (for discrimination of soil and plants), and a polarization sensor (or a stereo camera or a ToF sensor) (for gauging angles of leaves)
Output: information related to leaves and individuals such as chlorophyll concentration of leaves

By gauging the angles of leaves, BRDF (Bidirectional Reflectance Distribution Function) correction (optical correction) becomes possible, and the precision can be enhanced.
Macro-measurement: infrared rays
Micro-measurement: RGB, NDVI, NIR reflectance (for sun leaf discrimination), and a polarization sensor (or a stereo camera or a ToF sensor) (for gauging angles of leaves)
Output: information related to the transpiration rate of leaves

The leaf temperature can be measured by using infrared rays, and the transpiration rate can be known from the leaf temperature. Although typically the leaf temperature varies largely depending on whether or not leaves are lit by sunlight, extraction of sun leaves, gauging of the angles of the leaves, and extraction of only values meeting the same condition allow inter-individual comparison of decreases of the leaf temperature that accompany transpiration.

Explanations are given so far assuming that vegetation sensing is performed, but the technique in the present disclosure can be applied to a wide variety of fields.

For example, in a case where a central heating source is used in a building such as an office building, the energy use amount of the entire building can be known. However, an energy use amount of part of the building (e.g., an office occupying a particular floor is not known precisely in some cases.

In such a case, a measurement value of an energy use amount for each use such as illumination or an outlet of each location (each floor) of the building, if available, can be used to allow an estimation of the energy use amount of the office or the like.

In such a case, the energy use amount of the entire building is measured as macro-measurement.

In addition, an energy use amount for each use such as illumination or an outlet of each location of the building is measured as micro-measurement.

Then, an estimate value of an amount of energy used at part (e.g., a particular office) of the building can be obtained as output.

In addition, for example, in an example of fields such as labor statistics, the transition of the unemployment rate in a period with a certain length is measured as macro-measurement, and a seasonal index is generated based on the transition of the seasonal unemployment rate as micro-measurement.

Then, information of the transition of the unemployment rate is adjusted by the seasonal index, and the adjusted information is output. Thereby, for example, information that allows observation of the transition of the unemployment rate excluding the influence of seasonal factors can be obtained.

### 5. Summary and Modification

According to the embodiment explained above, following effects can be obtained.

The information processing apparatus 1 in the embodiment includes the macro-measurement analysis calculating section 21 that performs calculation of detection data from the macro-measurement section 2 that performs sensing of the macro-measurement area RZ2 (first measurement area) of a measurement target at the macro-measurement resolution (first spatial resolution). In addition, the information processing apparatus 1 includes the micro-measurement analysis calculating section 23 that performs calculation of detection data from the micro-measurement section 3 that performs sensing of the micro-measurement area RZ3 (second measurement area) included in the macro-measurement area RZ2 at the micro-measurement resolution (second spatial resolution) which is resolution higher than before the macro-measurement resolution. Furthermore, the information processing apparatus 1 includes the complementary analysis calculating section 27 that performs complementary analysis calculation by using a result of calculation by the macro-measurement analysis calculating section 21, and a result of calculation by the micro-measurement analysis calculating section 23 to generate complementary analysis information.

In this case, by performing calculation by using, in combination, the detection data of the micro-measurement section 3 that is capable of sensing at high spatial resolution and the detection data of the macro-measurement section 2 that has low spatial resolution, but is capable of highly functional sensing, it becomes possible to measure the phenotypic trait or the environmental response of a measurement target that could not be measured by the micro-measurement section 3 alone or by the macro-measurement section 2 alone.

In the information processing apparatus 1 of the embodiment, complementary analysis calculation includes calculation processing of complementing a result of calculation by the macro-measurement analysis calculating section 21 by using a result of calculation by the micro-measurement analysis calculating section 23.

Thereby, detection precision can be enhanced by increasing the resolution of a calculation result of macro analysis by using a result of calculation by the micro-measurement analysis calculating section, for example.

It is assumed that in the information processing apparatus 1 of the embodiment, the resolution of a result of calculation by the micro-measurement analysis calculating section 23 is higher than the resolution of a result of calculation by the macro-measurement analysis calculating section 22. Thereby, a complementary analysis calculation result in which information that is not represented in the result of calculation by the macro-measurement analysis calculating section is complementarily added by using the result of calculation by the micro-measurement analysis calculating section can be obtained.

In an example explained in the embodiment, the information processing apparatus 1 generates, by means of the complementary analysis calculating section 27, complementary analysis information including physical property values of a particular target discriminated in the micro-measurement area RZ3 as a result of analysis by the micro-measurement analysis calculating section 23, which physical property values are determined as physical property values in the unit of macro-measurement resolution which are a result of analysis by the macro-measurement analysis calculating section 21.

Detection data of the micro-measurement section 3 that is capable of sensing at high spatial resolution is advantageous in discrimination of a target in a measurement area. For example, discrimination of the portions of leaves that are lit by sunlight (sun leaves), discrimination of soil and leaves, and the like are suited to be performed by using detection data of the micro-measurement section 3.

On the other hand, detection data of the macro-measurement section 2 that is capable of highly functional sensing allows detailed calculation of physical property values. Accordingly, complementary analysis information making use of the advantages of the micro-measurement section 3 and macro-measurement section 2 can be obtained.

For example, along with the phenotypic trait, the environmental response, the distribution and the like of a discriminated measurement target, a result of analysis representing an environmental response such as information related to photosynthesis such as SIF mentioned above can be obtained.

In an example explained in the embodiment, physical property values are information related to photosynthesis of plants.

Examples of information related to photosynthesis include SIF, and various types of information calculated from SIF, for example.

In this case, it becomes possible to output the information related to photosynthesis according to the phenotypic trait, the environmental response, the area, the distribution and the like based on micro-measurement.

In an example explained in the embodiment, the micro-measurement analysis calculating section 23 performs discrimination of a gauging target on the basis of an RGB image or information related to a vegetation index.

For example, an RGB image or an NDVI image is used to perform discrimination by a technique such as comparison with a predetermined threshold.

In this case, for example, discrimination of the portions of sun leaves, discrimination of the portions of soil and plants, and the like can be performed appropriately. In particular, in a case where information related to photosynthesis is obtained by the macro-measurement section 2, more meaningful information can be output by making it possible to display the information related to photosynthesis (e.g., SIF) along with a result of discrimination of sun-leaf portions or plant portions or by adjusting values.

In the embodiment, the macro-measurement section 2 is arranged at a position farther from the measurement target 4 (e.g., the cultivated land 300) than the micro-measurement section 3 is, to perform sensing.

By making the macro-measurement section 2 relatively far away from the measurement target 4, it becomes easy to realize a relatively large apparatus or device as the macro-measurement section 2 or an apparatus on which the macro-measurement section 2 is mounted.

Note that although in the example explained, the micro-measurement section 3 is mounted on the aerial vehicle 200, and the macro-measurement section 2 is mounted on the artificial satellite 210, the macro-measurement section 2 may also be mounted on an aerial vehicle 200 such as a drone. For example, it is possible to mount the macro-measurement section 2 on an aerial vehicle 200 that flies higher in the air, and cause the macro-measurement section 2 to perform sensing of the macro-measurement area RZ2.

In an example explained in the embodiment, the macro-measurement section 2 is mounted on the artificial satellite 210.

Since it is easier to mount a relatively highly functional or relatively large-scale sensor on the artificial satellite 210, the artificial satellite 210 is suited for mounting of the macro-measurement section 2 that performs advanced sensing.

For example, by allowing a large number of farmers, sensing-performing organizations and the like to share the macro-measurement section 2 of the artificial satellite 210, it is also possible to attempt to reduce operational costs or to effectively use the macro-measurement sensor 2S.

Note that in a possible example, without using the artificial satellite 210, the macro-measurement section 2 is mounted on the aerial vehicle 200 or a relatively large-sized aerial vehicle, and is caused to perform sensing from a position higher than the micro-measurement section 3.

In an example explained in the embodiment, the micro-measurement section 3 is mounted on the aerial vehicle 200 that can be manipulated wirelessly or by an autopilot.

Examples of the aerial vehicle 200 that can be manipulated wirelessly or by an autopilot include so-called drones, small-sized wirelessly-manipulated fixed-wing airplanes, small-sized wirelessly-manipulated helicopters and the like.

In a case of the small-sized aerial vehicle 200, sensing is performed at a relatively low altitude from a measurement target such as the cultivated land 300. Then, this case is suited for sensing at high spatial resolving power.

In addition, by not mounting the macro-measurement section 2 on the aerial vehicle 200, it becomes easier to operate the small-sized aerial vehicle 200 or becomes possible to reduce costs for performing sensing.

In an exampled mentioned in the embodiment, the micro-measurement section 3 has, as the micro-measurement sensor 3S, any of a visible light image sensor, a stereo camera, a laser image detection and ranging sensor, a polarization sensor, or a ToF sensor.

These are sensors suited for analysis of the phenotypic trait, the environmental response, the area, the distribution, and the like of a measurement target such as analysis of the shape, for example.

In addition, these are sensors that can be mounted on the aerial vehicle 200 relatively easily, and are suited for operation of the aerial vehicle 200 as a small-sized unmanned aerial vehicle such as a drone.

In an example explained in the embodiment, the macro-measurement section 2 has, as the macro-measurement sensor 2S, any of a multi spectrum camera, a hyper spectrum camera, a Fourier transform infrared spectrophotometer, or an infrared sensor.

These are sensor suited for analysis of various types of physical property value such as information related to photosynthesis, for example.

In addition, these are sensors that can be mounted on aerial vehicles 200 relatively less easily. Then, for example, in a case where it is mounted on the artificial satellite 210, operation of the aerial vehicle 200 as a small-sized unmanned aerial vehicle such as a drone can be facilitated.

In an example explained in the embodiment, the information processing apparatus 1 has the complementary analysis calculation program/data holding section 26 as a holding section that holds the complementary analysis calculation program of the complementary analysis calculating section input from an external apparatus.

That is, the program defining the calculation algorithm of the complementary analysis calculating section can be acquired from an external apparatus.

For example, a program for the complementary analysis calculation is acquired from an external apparatus such as a network 5 or storage device 6 and stored in the complementary analysis calculation program/data holding section 26, and calculation of the complementary analysis calculating section 27 is performed on the basis of the program. Thereby, it becomes possible for the information processing apparatus 1 to perform a wide variety of complementary analysis calculation.

The information processing apparatus 1 of the embodiment has the data storage/output section 30 that generates and outputs image data based on the complementary analysis information.

The complementary analysis result is not suited for an image to be visually recognized by a human when the complementary analysis result is used unmodified in some cases (the result of evaluation is hard to understand). Then, the data storage/output section 30 converts the complementary analysis result into an image which is in a state suited for presentation to humans, and the image is output to the display section 56, a network 5, or a storage device 6. Thereby, an image that allows easier understanding of the complementary analysis result can be provided to a user.

In an example explained in the embodiment, the data storage/output section 30 generates an output image in which a complementary analysis result is color-mapped (see FIG. 15).

That is, in a case where the complementary analysis result is obtained for each area corresponding to the macro resolution unit, an image for presentation to a user is generated as an image in which a color is applied to each area.

Thereby, an image that allows recognition of a result of analysis based on colors can be provided to a user.

In an example explained in the embodiment, the data storage/output section 30 generates an output image obtained by synthesizing an image in which a complementary analysis result is color-mapped, with a second image (see FIG. 16 and FIG. 17).

By synthesizing a second image and a color-mapped image in a form such as overlaying or overwriting, for example, the data storage/output section 30 can provide a user with an image that allows recognition of a result of evaluation based on colors for each area while at the same time the second image allows recognition of each area.

In the embodiment, a second image to be synthesized with an image in which a complementary analysis result is color-mapped is an image based on a result of calculation by the micro-measurement analysis calculating section. For example, it is an image NDVIp-pr (see FIG. 16).

Thereby, an image that allows visual recognition of information obtained in the macro-measurement on an image that expresses a result of discrimination in the micro-measurement area RZ3 can be provided to a user.

In the embodiment, an output image is an image representing a complementary analysis result in the unit of macro-measurement resolution regarding an image of the micro-measurement area RZ3 (see FIG. 15, FIG. 16, and FIG. 17).

Thereby, an image that allows visual recognition of information obtained in the macro-measurement along with a measurement target in the micro-measurement area RZ3 can be provided to a user.

Note that an output image may be an image representing a complementary analysis result in the unit of macro-measurement resolution not regarding an image representing the entire micro-measurement area RZ3, but regarding an image representing part of the micro-measurement area RZ3.

The program in the embodiment causes the information processing apparatus 1 to execute macro-measurement analysis calculation processing of performing calculation of detection data from the macro-measurement section 2 that performs sensing of the macro-measurement area RZ2 of a measurement target at the macro-measurement resolution. In addition, the program causes the information processing apparatus 1 to execute micro-measurement analysis calculation processing of performing calculation of detection data from the micro-measurement section 3 that performs sensing of the micro-measurement area RZ3 included in the macro-measurement area RZ2 at the micro-measurement resolution which is resolution higher than before the macro-measurement resolution. Furthermore, the program causes the information processing apparatus 1 to execute complementary analysis calculation processing of performing complementary analysis calculation by using a result of calculation by the macro-measurement analysis calculating section 21, and a result of calculation by the micro-measurement analysis calculating section 23, and of generating complementary analysis information.

That is, it is a program that causes the information processing apparatus to execute the processing of FIG. 8, FIG. 9, and FIG. 12.

Realization of the image processing apparatus 1 of the present embodiment is facilitated by such a program.

Then, such a program can be stored in advance in a recording medium incorporated into equipment such as a computer apparatus, a ROM in a microcomputer having a CPU, and the like. Alternatively, such a program can also be temporarily or permanently saved (stored) in a removable recording medium such as a semiconductor memory, a memory card, an optical disc, a magneto-optical disk, or a magnetic disk. In addition, such a removable recording medium can be provided as so-called packaged software.

In addition, other than being installed on a personal computer or the like from a removable recording medium, such a program can also be downloaded via a network such as a LAN or the internet from a download site.

Note that the effects described in the present specification are merely illustrated as examples, and are not the only effects. There may also be other effects.

It should be understood by those skilled in the art that various modifications, combinations, sub-combinations and alterations may occur depending on design requirements and other factors insofar as they are within the scope of the appended claims or the equivalents thereof.

Note that the present technique can have following configurations.

(1)

An information processing apparatus including:

a macro-measurement analysis calculating section that performs calculation of detection data from a macro-measurement section that performs sensing of a first measurement area of a measurement target at first spatial resolution;

a micro-measurement analysis calculating section that performs calculation of detection data from a micro-measurement section that performs sensing of a second measurement area included in the first measurement area of the measurement target at second spatial resolution which is resolution higher than the first spatial resolution; and

a complementary analysis calculating section that performs complementary analysis calculation by using a result of calculation by the macro-measurement analysis calculating section, and a result of calculation by the micro-measurement analysis calculating section, and generates complementary analysis information.

(2)

The information processing apparatus according to (1) (2) explained above, in which

the complementary analysis calculation includes calculation processing of complementing the result of calculation by the macro-measurement analysis calculating section by using the result of calculation by the micro-measurement analysis calculating section.

(3)

The information processing apparatus according to (1) or (2) explained above, in which

resolution of the result of calculation by the micro-measurement analysis calculating section is higher than resolution of the result of calculation by the macro-measurement analysis calculating section.

(4)

The information processing apparatus according to any one of (1) to (3) explained above, in which

the complementary analysis calculating section generates complementary analysis information which is a physical property value of a particular target discriminated as a result of analysis of the second measurement area by the micro-measurement analysis calculating section, the physical property value being determined as a physical property value in a unit of the first spatial resolution which is a result of analysis by the macro-measurement analysis calculating section.

(5)

The information processing apparatus according to (4) explained above, in which

the physical property value includes information related to photosynthesis of a plant.

(6)

The information processing apparatus according to (4) or (5) explained above, in which

the micro-measurement analysis calculating section performs discrimination of a gauging target on the basis of an RGB image or information related to a vegetation index.

(7)

The information processing apparatus according to any one of (1) to (6) explained above, in which

the macro-measurement section performs sensing at a position farther from the measurement target than a position of the micro-measurement section is.

(8)

The information processing apparatus according to any one of (1) to (7) explained above, in which

the macro-measurement section is mounted on an artificial satellite.

(9)

The information processing apparatus according to any one of (1) to (8) explained above, in which

the micro-measurement section is mounted on an aerial vehicle that can be manipulated wirelessly or by an autopilot.

(10)

The information processing apparatus according to any one of (1) to (9) explained above, in which

the micro-measurement section has, as a micro-measurement sensor, any of a visible light image sensor, a stereo camera, a laser image detection and ranging sensor, a polarization sensor, or a ToF sensor.

(11)

The information processing apparatus according to any one of (1) to (10) explained above, in which

the macro-measurement section has, as a macro-measurement sensor, any of a multi spectrum camera, a hyper spectrum camera, a Fourier transform infrared spectrophotometer, or an infrared sensor.

(12)

The information processing apparatus according to any one of (1) to (11) explained above, further including:

a holding section that holds a complementary analysis calculation program of the complementary analysis calculating section input from an external apparatus.

(13)

The information processing apparatus according to any one of (1) to (12) explained above, further including:

an output section that generates output image data which is based on the complementary analysis information, and outputs the output image data.

(14)

The information processing apparatus according to (13) explained above, in which

the output section generates output image data in which a complementary analysis result is color-mapped.

(15)

The information processing apparatus according to (13) explained above, in which

the output section generates output image data obtained by synthesizing a second image and an image in which a complementary analysis result is color-mapped.

(16)

The information processing apparatus according to (15) explained above, in which

the second image includes an image based on the calculation result of the micro-measurement analysis calculating section.

(17)

The information processing apparatus according to any one of (13) to (15) explained above, in which

the output image data includes image data indicating a complementary analysis result of an image representing an entire part of or a part of the second measurement area in a unit of the first spatial resolution.

(18)

An information processing method in which an information processing apparatus executes:

macro-measurement analysis calculation processing of performing calculation of detection data from a macro-measurement section that performs sensing of a first measurement area of a measurement target at first spatial resolution;

micro-measurement analysis calculation processing of performing calculation of detection data from a micro-measurement section that performs sensing of a second measurement area included in the first measurement area of the measurement target at second spatial resolution which is resolution higher than the first spatial resolution; and

complementary analysis calculation processing of performing complementary analysis calculation by using a result of calculation in the macro-measurement analysis calculation processing, and a result of calculation in the micro-measurement analysis calculation processing, and of generating complementary analysis information.

(19)

A program causing an information processing apparatus to execute:

macro-measurement analysis calculation processing of performing calculation of detection data from a macro-measurement section that performs sensing of a first measurement area of a measurement target at first spatial resolution;

micro-measurement analysis calculation processing of performing calculation of detection data from a micro-measurement section that performs sensing of a second measurement area included in the first measurement area of the measurement target at second spatial resolution which is resolution higher than the first spatial resolution; and

complementary analysis calculation processing of performing complementary analysis calculation by using a result of calculation in the macro-measurement analysis calculation processing, and a result of calculation in the micro-measurement analysis calculation processing, and of generating complementary analysis information.

(20)

A sensing system including:

a macro-measurement section that performs sensing of a first measurement area of a measurement target at first spatial resolution;

a micro-measurement section that performs sensing of a second measurement area included in the first measurement area of the measurement target at second spatial resolution which is resolution higher than the first spatial resolution;

a macro-measurement analysis calculating section that performs calculation of detection data from the macro-measurement section;

a micro-measurement analysis calculating section that performs calculation of detection data from the micro-measurement section; and

a complementary analysis calculating section that performs complementary analysis calculation by using a result of calculation by the macro-measurement analysis calculating section, and a result of calculation by the micro-measurement analysis calculating section, and generates complementary analysis information.

### REFERENCE SIGNS LIST

1: Information processing apparatus, 2: Macro-measurement section, 2S: Macro-measurement sensor, 3: Micro-measurement section, 3S: Micro-measurement sensor, 4: Gauging target, 5: Network, 6: Storage device, 10: Data input section, 11: Sensor input section, 12: Sensor input section, 13: Program/data input section, 20: Complementary analysis executing section, 21: Macro-measurement analysis calculating section, 22: Macro-measurement analysis value buffer, 23: Micro-measurement analysis calculating section, 24: Micro-measurement analysis value buffer, 25: Position mapping section, 26: Complementary analysis calculation program/data holding section, 27: Complementary analysis calculating section 30: Data storage/output section 31: Analysis data buffer 32: Color mapping section 33: Image synthesizing section 34: Graph generating section 35: Image output section 36: Data output section 51: CPU 52: ROM 53: RAM 54: Bus 55: Input/output interface 56: Display section 57: Input section 58: Speaker 59: Storage section 60: Communication section 61: Drive 200: Aerial vehicle 210: Artificial satellite 220: Image-capturing apparatus 250: Image-capturing apparatus 300: Cultivated land

1. An information processing apparatus comprising:
a macro-measurement analysis calculating section that performs calculation of detection data from a macro-measurement section that performs sensing of a first measurement area of a measurement target at first spatial resolution;
a micro-measurement analysis calculating section that performs calculation of detection data from a micro-measurement section that performs sensing of a second measurement area included in the first measurement area of the measurement target at second spatial resolution which is resolution higher than the first spatial resolution; and
a complementary analysis calculating section that performs complementary analysis calculation by using a result of calculation by the macro-measurement analysis calculating section, and a result of calculation by the micro-measurement analysis calculating section, and generates complementary analysis information.

2. The information processing apparatus according to claim 1, wherein
the complementary analysis calculation includes calculation processing of complementing the result of calculation by the macro-measurement analysis calculating section by using the result of calculation by the micro-measurement analysis calculating section.

3. The information processing apparatus according to claim 1, wherein
resolution of the result of calculation by the micro-measurement analysis calculating section is higher than resolution of the result of calculation by the macro-measurement analysis calculating section.

4. The information processing apparatus according to claim 1, wherein
the complementary analysis calculating section generates complementary analysis information which is a physical property value of a particular target discriminated as a result of analysis of the second measurement area by the micro-measurement analysis calculating section, the physical property value being determined as a physical property value in a unit of the first spatial resolution which is a result of analysis by the macro-measurement analysis calculating section.

5. The information processing apparatus according to claim 4, wherein
the physical property value includes information related to photosynthesis of a plant.

6. The information processing apparatus according to claim 4, wherein
the micro-measurement analysis calculating section performs discrimination of a gauging target on a basis of an RGB image or information related to a vegetation index.

7. The information processing apparatus according to claim 1, wherein
the macro-measurement section performs sensing at a position farther from the measurement target than a position of the micro-measurement section is.

8. The information processing apparatus according to claim 1, wherein
the macro-measurement section is mounted on an artificial satellite.

9. The information processing apparatus according to claim 1, wherein
the micro-measurement section is mounted on an aerial vehicle that can be manipulated wirelessly or by an autopilot.

10. The information processing apparatus according to claim 1, wherein
the micro-measurement section has, as a micro-measurement sensor, any of a visible light image sensor, a stereo camera, a laser image detection and ranging sensor, a polarization sensor, or a ToF sensor.

11. The information processing apparatus according to claim 1, wherein
the macro-measurement section has, as a macro-measurement sensor, any of a multi spectrum camera, a hyper spectrum camera, a Fourier transform infrared spectrophotometer, or an infrared sensor.

12. The information processing apparatus according to claim 1, further comprising:
a holding section that holds a complementary analysis calculation program of the complementary analysis calculating section input from an external apparatus.

13. The information processing apparatus according to claim 1, further comprising:
an output section that generates output image data which is based on the complementary analysis information, and outputs the output image data.

14. The information processing apparatus according to claim 13, wherein
the output section generates output image data in which a complementary analysis result is color-mapped.

15. The information processing apparatus according to claim 13, wherein
the output section generates output image data obtained by synthesizing a second image and an image in which a complementary analysis result is color-mapped.

16. The information processing apparatus according to claim 15, wherein
the second image includes an image based on the calculation result of the micro-measurement analysis calculating section.

17. The information processing apparatus according to claim 13, wherein
the output image data includes image data indicating a complementary analysis result of an image representing an entire part of or a part of the second measurement area in a unit of the first spatial resolution.

18. An information processing method in which an information processing apparatus executes:
macro-measurement analysis calculation processing of performing calculation of detection data from a macro-measurement section that performs sensing of a first measurement area of a measurement target at first spatial resolution;
micro-measurement analysis calculation processing of performing calculation of detection data from a micro-measurement section that performs sensing of a second measurement area included in the first measurement area of the measurement target at second spatial resolution which is resolution higher than the first spatial resolution; and
complementary analysis calculation processing of performing complementary analysis calculation by using a result of calculation in the macro-measurement analysis calculation processing, and a result of calculation in the micro-measurement analysis calculation processing, and of generating complementary analysis information.

19. A program causing an information processing apparatus to execute:
macro-measurement analysis calculation processing of performing calculation of detection data from a macro-measurement section that performs sensing of a first measurement area of a measurement target at first spatial resolution;
micro-measurement analysis calculation processing of performing calculation of detection data from a micro-measurement section that performs sensing of a second measurement area included in the first measurement area of the measurement target at second spatial resolution which is resolution higher than the first spatial resolution; and
complementary analysis calculation processing of performing complementary analysis calculation by using a result of calculation in the macro-measurement analysis calculation processing, and a result of calculation in the micro-measurement analysis calculation processing, and of generating complementary analysis information.

20. A sensing system comprising:
a macro-measurement section that performs sensing of a first measurement area of a measurement target at first spatial resolution;
a micro-measurement section that performs sensing of a second measurement area included in the first measurement area of the measurement target at second spatial resolution which is resolution higher than the first spatial resolution;
a macro-measurement analysis calculating section that performs calculation of detection data from the macro-measurement section;
a micro-measurement analysis calculating section that performs calculation of detection data from the micro-measurement section; and
a complementary analysis calculating section that performs complementary analysis calculation by using a result of calculation by the macro-measurement analysis calculating section, and a result of calculation by the micro-measurement analysis calculating section, and generates complementary analysis information.
